(19) United States
(12) Patent Application Publication
(10) Pub. No.: US 2025/0078360 A1
(43) Pub. Date: Mar. 6, 2025

(54) INFORMATION PROCESSING APPARATUS, METHOD OF CONTROLLING THE SAME, AND STORAGE MEDIUM

(71) Applicant: CANON KABUSHIKI KAISHA, Tokyo (JP)

(72) Inventors: KAZUYA OGASAWARA, Kanagawa (JP); TAKAYUKI YAMADA, Kanagawa (JP); KOUTA MURASAWA, Kanagawa (JP); KAZUFUMI KONDO, Kanagawa (JP); SHINJIRO HORI, Kanagawa (JP)

(21) Appl. No.: 18/814,699

(22) Filed: Aug. 26, 2024

(30) Foreign Application Priority Data
Aug. 30, 2023 (JP) 2023-140271

(51) Int. Cl. G06T 11/60; G06F 3/04845; G06F 3/04847

(52) U.S. Cl. CPC G06T 11/60; G06F 3/04845; G06F 3/04847

(57) ABSTRACT

An information processing apparatus receives, from a user, a designation of a target impression of a poster to be generated, receives, from a user, a designation of a target quality of the poster to be generated, and generates one or more pieces of poster data based on at least the target impression. The information processing apparatus calculates an evaluation value based on first information indicating a difference between the target impression and a degree of impression of each of the one or more pieces of poster data and second information indicating a difference between the target quality and a quality of each of the one or more pieces of poster data, and selects, from the one or more pieces of poster data, a poster for which the evaluation value has an evaluation higher than a predetermined evaluation.

### BACKGROUND OF THE INVENTION

### Field of the Invention

The present invention relates to an information processing apparatus, a method of controlling the same, and a storage medium.

### Description of the Related Art

Conventionally, a method has been proposed in which a poster is generated by preparing a template that stores information indicating images, characters, shapes such as graphics, and an arrangement, which constitute a poster, and then automatically arranging images, characters, graphics, and the like according to the template.

Japanese Patent Publication No. 6537419 describes generating a poster by selecting templates in ascending order of difference between an impression evaluation value of the template and an impression evaluation value of an image.

In Japanese Patent Publication No. 6537419, a template is selected in which the difference between the impression evaluation value of the template and the impression evaluation value of the image is small, but no consideration is given to generating a poster that expresses a user's intended degree of impression (hereinafter referred to as a “target impression”).

Also, there is a trade-off between bringing the target impression closer to the degree of impression given by the poster to be generated and improving the quality of the poster to be generated. The quality of a poster refers to the quality of its poster design. For example, with posters, a quality poster design can be said to be one that is well-balanced overall, eye-catching, and easy to see and read. On the other hand, if a poster is generated with consideration given only to approximating the target impression, there are cases where it is not possible to achieve the poster quality desired by the user (hereinafter referred to as “target quality”), and the poster desired by the user cannot be generated.

For example, a problem will be described with reference to FIGS. 16A and 16B, taking the case of generating a poster with strong degree of dynamism as an example. As shown in FIG. 16A, a poster that uses many expressions that enhance the degree of dynamism, such as tilting objects or using a large number of colors, gives a strong sense of dynamism, but the balance of the design is lost and the quality of the poster is reduced. In contrast, as shown in FIG. 16B, a poster with a more gentle object tilt and fewer colors has a somewhat weaker degree of dynamism compared to FIG. 16A, but the design is well-balanced and the quality of the poster is improved.

### SUMMARY OF THE INVENTION

Embodiments of the present disclosure eliminate the above-mentioned issues with conventional technology.

A feature of embodiments of the present disclosure is to provide a technique for generating poster data that reflects a user's intention regarding a degree of impression and quality of poster data.

According to embodiments of the present disclosure, there is provided an information processing apparatus comprising: one or more controllers including one or more processors and one or more memories, the one or more controllers configured to: receive, from a user, a designation of a target impression of a poster to be generated; receive, from a user, a designation of a target quality of the poster to be generated; generate one or more pieces of poster data based on at least the target impression; calculate an evaluation value based on first information indicating a difference between the target impression and a degree of impression of each of the one or more pieces of poster data and second information indicating a difference between the target quality and a quality of each of the one or more pieces of poster data; and select, from the one or more pieces of poster data, a poster for which the evaluation value has an evaluation higher than a predetermined evaluation.

According to embodiments of the present disclosure, there is provided a method of controlling an information processing apparatus, the method comprising: receiving, from a user, a designation of a target impression of a poster to be generated; receiving, from a user, a designation of a target quality of the poster to be generated; generating one or more pieces of poster data based on at least the target impression; calculating an evaluation value based on first information indicating a difference between the target impression and a degree of impression of each of the one or more pieces of poster data and second information indicating a difference between the target quality and a quality of each of the one or more pieces of poster data; and selecting, from the one or more pieces of poster data, poster data for which the evaluation value has an evaluation higher than a predetermined evaluation.

Further features of the present disclosure will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a block diagram for describing a hardware configuration of a poster generation apparatus according to a first embodiment.

FIG. 2 is a functional block diagram for describing functions of a poster creation application according to the first embodiment.

FIGS. 3A and 3B are diagrams showing an example of a skeleton according to the first embodiment.

FIG. 4 is a diagram showing an example of a table of color patterns according to the first embodiment.

FIG. 5 is a diagram showing an example of an application start-up screen provided by the poster creation application according to the first embodiment.

FIG. 6 is a diagram showing an example of a poster preview screen displayed by a poster display module in the first embodiment.

FIG. 7 is a flowchart for describing impression quantification processing for a poster, which is executed by the poster generation apparatus according to the first embodiment.

FIG. 8 is a diagram for describing an example of a subjective evaluation method for a degree of impression of a poster.

FIG. 9A is a flowchart for describing poster generation processing performed by a poster generation module of the poster creation application according to the first embodiment.

FIG. 9B is a flowchart for describing condition determination processing performed by a skeleton obtaining module.

FIGS. 10A to 10C are diagrams for describing a method in which a skeleton selection module according to the first embodiment selects a skeleton.

FIGS. 11A and 11B are diagrams showing examples of a color pattern impression table and a font impression table according to the first embodiment.

FIG. 12 is a functional block diagram for describing functions of a layout module according to the first embodiment.

FIG. 13 is a flowchart for describing layout processing in step S910 of FIG. 9A.

FIGS. 14A to 14C are diagrams illustrating information input to the layout module.

FIGS. 15A to 15C are diagrams for describing a process of processing performed by the layout module.

FIGS. 16A and 16B are diagrams illustrating a problem to be solved.

FIG. 17 is a flowchart for describing poster generation processing implementing processing for quantifying poster quality.

FIG. 18 is a diagram for describing an example of a subjective evaluation method for the quality of a poster.

FIGS. 19A to 19D are diagrams for describing a difference between a degree of impression and quality.

FIG. 20 is a flowchart for describing evaluation value calculation processing in step S913.

FIG. 21 is a diagram showing an example of a poster preview screen that displays a poster image generated by a poster display module according to a modified example of the first embodiment.

FIG. 22 is a functional block diagram for describing functions of a poster creation application according to a second embodiment.

FIG. 23 is a flowchart for describing processing performed by a poster generation module of the poster creation application according to the second embodiment.

FIG. 24 is a flowchart for describing processing for retouching poster data, which is performed by a design retouching module according to the second embodiment.

### DESCRIPTION OF THE EMBODIMENTS

Embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted.

In the embodiment described below, a method of automatically generating a poster by running an application (hereinafter, simply referred to as an “app”) for creating a poster in the poster generation apparatus will be described as an example. Note that in the following description, unless otherwise specified, the term “image” includes a still image and a frame image extracted from a moving image.

### First Embodiment

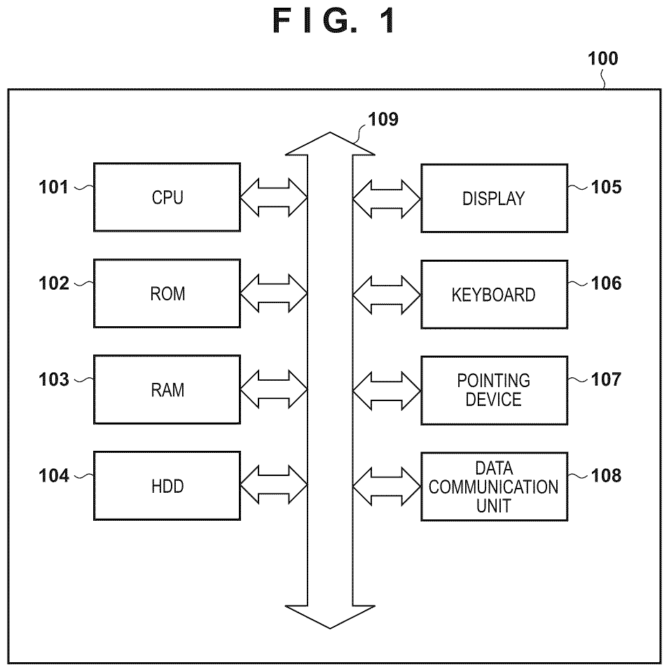

FIG. 1 is a block diagram for describing a hardware configuration of a poster generation apparatus 100 according to the first embodiment. Note that the poster generation apparatus 100 is an example of an information processing apparatus, such as a personal computer (hereinafter, PC) or a smartphone. In the embodiment, the poster generation apparatus will be described as having the same hardware configuration as a PC.

The poster generation apparatus 100 includes a CPU 101, a ROM 102, a RAM 103, a hard disk drive (HDD) 104, a display 105, a keyboard 106, a pointing device 107, and a data communication unit 108.

The CPU (Central Processing Unit/Processor) 101 performs overall control of the poster generation apparatus 100, and for example, deploys a program stored in the ROM 102 to the RAM 103 and executes the program to realize operations according to the embodiment. In FIG. 1, there is one CPU, but there may also be a plurality of CPUs. The ROM 102 is a general-purpose ROM, and for example, stores programs to be executed by the CPU 101, various types of data, and the like. The RAM 103 is a general-purpose RAM, and is used, for example, as a working memory for temporarily storing various types of information when the CPU 101 executes a program. The HDD 104 is a storage medium (storage unit) for storing image files, a database for holding the results of processing such as image analysis, and skeletons to be used by a poster creation application. The display 105 is a display unit that displays a user interface (UI) according to the embodiment, and an electronic poster as a result of performing layout of image data (hereinafter referred to in some cases as an “image”) to a user. The keyboard 106 and the pointing device 107 receive instruction operations from the user. The display 105 may also include a touch sensor function. The keyboard 106 is used, for example, when a user inputs a number of double spreads of a poster that he or she wishes to create on the UI displayed on the display 105. The pointing device 107 is used, for example, when the user clicks a button on the UI displayed on the display 105. The data communication unit 108 communicates with an external device via a wired or wireless network. For example, the data communication unit 108 transmits data subjected to layout by an automatic layout function to a printer or a server capable of communicating with the poster generation apparatus 100. A system bus 109 connects the devices shown in FIG. 1 described above so that they can communicate with each other. Note that the configuration shown in FIG. 1 is merely an example and there is no limitation thereto. For example, the poster generation apparatus 100 need not have the display 105 and may display the UI on an external display.

The poster creation application according to the first embodiment is stored in the HDD 104. The poster creation application is started up when the user executes an operation such as clicking or double-clicking on an application icon displayed on the display 105 with the pointing device 107.

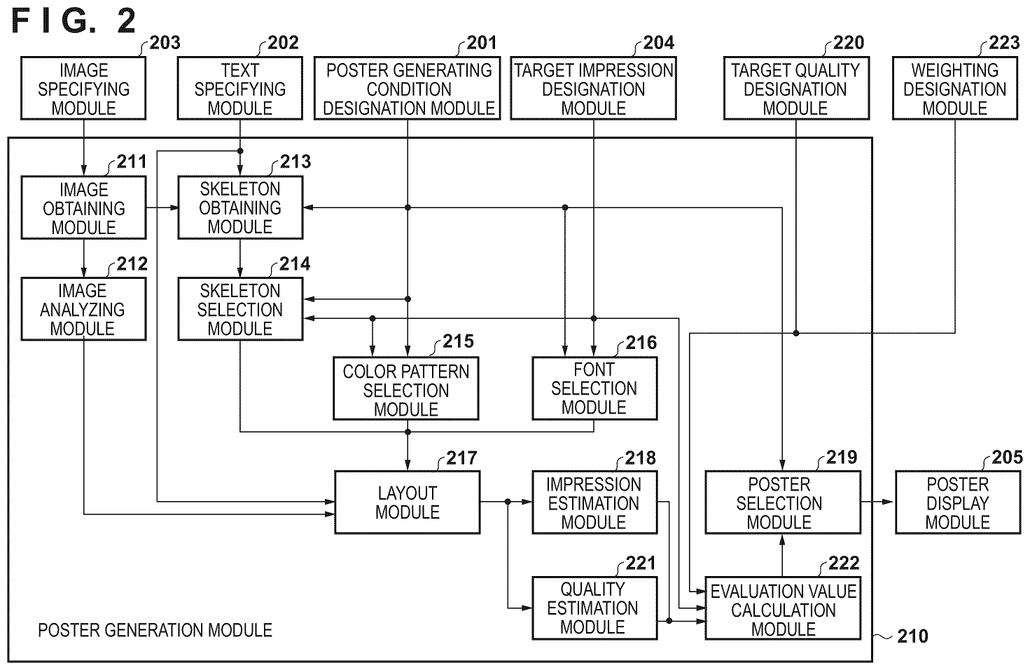

FIG. 2 is a functional block diagram for describing the functions of the poster creation application according to the first embodiment.

The poster creation application includes a poster generating condition designation module 201, a text specifying module 202, an image specifying module 203, a target impression designation module 204, a poster display module 205, a poster generation module 210, a target quality designation module 220, and a weighting designation module 223. The poster generation module 210 includes an image obtaining module 211, an image analyzing module 212, a skeleton obtaining module 213, a skeleton selection module 214, a color pattern selection module 215, a font selection module 216, and a layout module 217. Furthermore, the poster generation module 210 includes an impression estimation module 218, a poster selection module 219, a quality estimation module 221, and an evaluation value calculation module 222.

When the poster creation application is installed in the poster generation apparatus 100, a start-up icon is displayed on a top screen (desktop) of an operating system (OS) running on the poster generation apparatus 100. Then, the user operates (e.g., double-clicks on) the start-up icon displayed on the display 105 with the pointing device 107. As a result, the program for the poster creation application stored in the HDD 104 is deployed to the RAM 103 and executed by the CPU 101. This starts up the poster creation application.

The above-mentioned poster creation application includes program modules corresponding to the constituent elements shown in FIG. 2. The CPU 101 executes the program modules, whereby the CPU 101 functions as the constituent elements shown in FIG. 2. Hereinafter, the constituent elements shown in FIG. 2 will be described assuming that the constituent elements execute various types of processing. In particular, FIG. 2 also illustrates a block diagram of the software relating to the poster generation module 210 that executes an automatic poster creation function.

The poster generating condition designation module 201 designates poster generating conditions to the poster generation module 210 in response to a UI operation performed using the pointing device 107. In the first embodiment, the size of the poster, the number of posters to be created, the use category and the like are designated as the poster generating conditions. Note that the size of the poster may also be designated by designating the actual values of width and height, or may be specified by designating the paper size, such as A1 or A2. The use category is a category that indicates what the poster will be used for, such as a restaurant, a school event, a sale, or the like.

The text specifying module 202 specifies character information to be arranged on the poster according to a UI operation performed using the keyboard 106. The character information to be arranged on the poster includes character strings expressing, for example, a title, a date and time, a location and the like. The text specifying module 202 also makes it possible to distinguish each piece of character information by associating the character information with what type of information it is, such as a title, a date and time, a location, or the like and then outputs the character information to the skeleton obtaining module 213 and the layout module 217.

The image specifying module 203 specifies one or more pieces of image data that are stored in the HDD 104 and are to be arranged on the poster. The image data may be specified based on the structure of a file system that contains the image data, such as a device and directory, or may be specified by associated information for identifying the image, such as the shooting date and time, or attribute information. The image specifying module 203 outputs the file path of the specified image to the image obtaining module 211.

The target impression designation module 204 designates the target impression of the poster to be created. The target impression indicates a degree of the impression that the poster to be created is required to ultimately evoke. In the first embodiment, an intensity indicating the degree of an impression to be given to a word expressing the impression is specified through a UI operation performed using the pointing device 107. Information indicating the target impression designated in the target impression designation module 204 is shared by the skeleton selection module 214, the color pattern selection module 215, the font selection module 216, and the evaluation value calculation module 222. More details about degrees of impressions will be given later.

The target quality designation module 220 designates the target quality of the poster to be created. The target quality is the quality that the poster to be created is ultimately required to achieve. In the first embodiment, an intensity level indicating the level of quality to be achieved is specified through a UI operation performed using the pointing device 107. Here, quality may be expressed as an overall evaluation value of a design that combines images, graphics, characters, fonts, and the like included in the design. Information indicating the target quality designated in the target quality designation module 220 is shared with the evaluation value calculation module 222. More details on quality will be given later.

Next, the configuration of the poster generation module 210 will be described in detail.

The image obtaining module 211 obtains one or more pieces of image data specified by the image specifying module 203 from the HDD 104 and outputs the obtained image data to the image analyzing module 212. The image obtaining module 211 also outputs the number of obtained images to the skeleton obtaining module 213. Examples of the images stored in the HDD 104 include still images and frame images extracted from moving images. The still images and frame images are obtained from image capture devices such as digital cameras and smart devices. The image capturing device may be provided in the poster generation apparatus 100 or in an external device. Note that if the image capturing device is an external device, the images are obtained via the data communication unit 108. As another example, the still images may be illustrated images created using image editing software or CG images created using CG production software. The still images and clipped images may also be images obtained from a network or a server via the data communication unit 108. Examples of images obtained from a network or server include social networking service images (hereinafter referred to as “SNS images”). Also, the program executed by the CPU 101 analyzes data attached to each image to determine the storage source (obtaining destination). For example, the obtaining destination of the SNS image may be managed within the application by obtaining images from the SNS via the application. Note that the images are not limited to the above-mentioned images and may be other types of images.

The image analyzing module 212 executes analysis processing on the image data obtained from the image obtaining module 211 using a later-described method, and obtains information indicating a later-described image feature quantity. Specifically, the image analyzing module 212 executes later-described object recognition processing and obtains information indicating the image feature quantity of the image data. Also, the image analyzing module 212 associates information indicating the obtained image feature quantity with the image data and outputs the result to the layout module 217.

The skeleton obtaining module 213 obtains one or more skeletons that meet the conditions designated in the poster generating condition designation module 201, the text specifying module 202, and the image obtaining module 211 from the HDD 104. In the first embodiment, a skeleton is layout information that indicates the arrangement of character strings, images, graphics, and the like to be arranged on a poster.

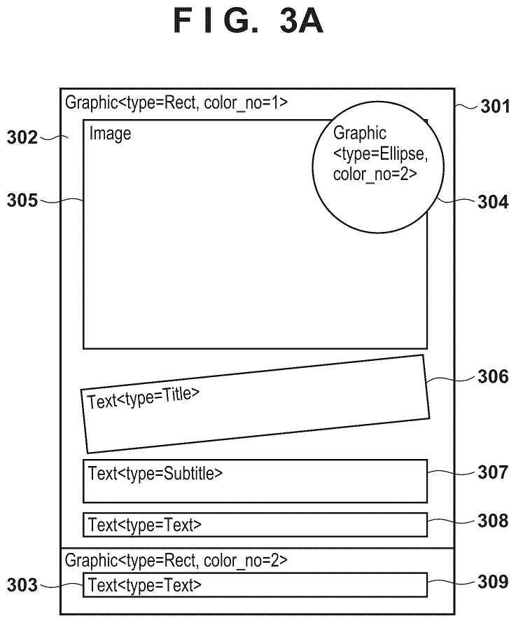

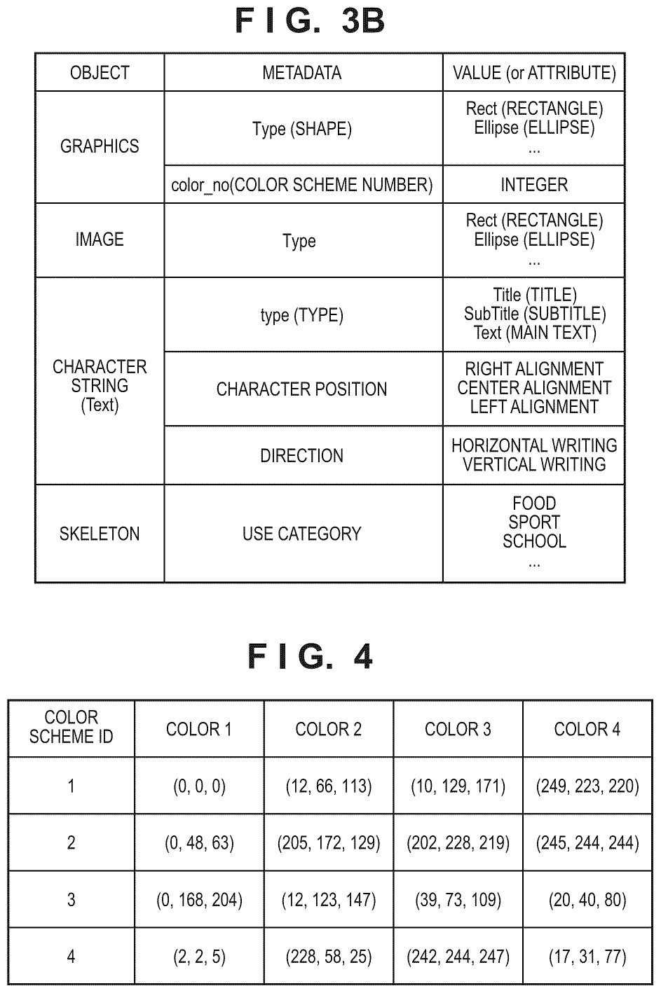

FIGS. 3A and 3B are diagrams showing an example of a skeleton according to the first embodiment.

Three graphic objects 302, 303, and 304, one image object 305, and four character objects 306, 307, 308, and 309, which are objects on which characters are arranged, are arranged on a skeleton 301 in FIG. 3A. Each object is recorded with its position indicating where it is to be arranged, its size, and its orientation, as well as metadata necessary to generate the poster.

FIG. 3B is a diagram showing an example of metadata. For example, the character objects 306 to 309 each hold, as a metadata attribute, information about the type of character information to be arranged. In FIG. 3A, the character object 306 represents a title, the character object 307 represents a subtitle, and the character objects 308 and 309 represent the main text to be arranged. Also, the character objects 306 to 309 hold information about the alignment positions of the characters as metadata attributes. For example, for a character object with a left alignment attribute, a character string is arranged such that the left edge of the input character string is aligned with the left edge of the character object, and for a character object with a center alignment attribute, a character string is arranged such that the center of the input string is aligned with the center of the character object.

Also, the graphic objects 302 to 304 each hold, as metadata attributes, a color scheme number (color scheme ID) indicating the shape of the graphic and the color pattern. In FIG. 3A, the attributes of the graphic objects 302 and 303 indicate that they are rectangles, and the attribute of the graphic object 304 indicates that it is an ellipse. Also, a color scheme number 1 (color_no=1) is assigned to the graphic object 302, and a color scheme number 2 is assigned to the graphic objects 303 and 304. Here, the color scheme number is information to be referenced when performing later-described color arrangement, and indicates that different colors are assigned to different color scheme numbers. Note that the types of objects and metadata are not limited to these. For example, there may be a map object for arranging a map, and a barcode object for arranging a QR code (registered trademark) or a barcode. Also, metadata for a character object may include metadata indicating the width between lines or the width between characters. The metadata may include the purpose of the skeleton, and may be used to control whether or not the skeleton can be used depending on the purpose. The skeleton may be stored in the HDD 104 in, for example, a CSV format, or in a DB format such as SQL. The skeleton obtaining module 213 outputs one or more skeletons obtained from the HDD 104 to the skeleton selection module 214.

The skeleton selection module 214 selects one or more skeletons that match the target impression specified by the target impression designation module 204 from the skeletons obtained from the skeleton obtaining module 213, and outputs the selected skeletons to the layout module 217. Since the skeleton determines the arrangement of the entire poster, by preparing various types of skeletons in advance, it is possible to increase the variety of generated posters.

The color pattern selection module 215 obtains, from the HDD 104, one or more color patterns that match the target impression designated by the target impression designation module 204, and outputs the obtained color patterns to the layout module 217. A color pattern is a combination of colors to be used in a poster.

FIG. 4 is a diagram showing an example of a table of color patterns according to the first embodiment. In the first embodiment, the color pattern is expressed as a combination of four colors (color 1 to color 4). The color scheme ID column in FIG. 4 is an ID for uniquely identifying a color pattern. The color 1 to color 4 columns represent colors in RGB order, with each RGB color value represented as 0 to 255 (R, G, B=(0 to 255, 0 to 255, 0 to 255)). Note that in the first embodiment, a color pattern including a combination of four colors was used, but other numbers of colors may be used, or a plurality of colors may be mixed.

The font selection module 216 selects one or more font patterns that match the target impression designated by the target impression designation module 204, obtains the selected font patterns from the HDD 104, and outputs them to the layout module 217. A font pattern is a combination of at least one of a title font, a subtitle font, and a main text font.

The layout module 217 lays out various types of data for each of the one or more skeletons obtained from the skeleton selection module 214, thereby generating one or more pieces of poster data, the number of which is greater than or equal to the designated number of posters to be created. The layout module 217 arranges the text obtained from the text specifying module 202 and the image data obtained from the image analyzing module 212 on each skeleton, applies the color pattern obtained from the color pattern selection module 215, and applies the font pattern obtained from the font selection module 216. The layout module 217 outputs one or more pieces of poster data generated in this way to the impression estimation module 218.

The impression estimation module 218 estimates a degree of impression of each piece of poster data among the plurality of pieces of poster data obtained from the layout module 217, and associates the degrees of impressions that were estimated (hereinafter referred to as “estimated impressions”) with the respective pieces of poster data. The impression estimation module 218 then outputs the one or more pieces of poster data associated with the estimated impressions to the evaluation value calculation module 222.

The quality estimation module 221 estimates the quality of each piece of poster data among the plurality of pieces of poster data obtained from the layout module 217, and associates the estimated qualities with the respective pieces of poster data. The quality estimation module 221 then outputs one or more pieces of poster data associated with the estimated qualities to the evaluation value calculation module 222.

The evaluation value calculation module 222 compares the target impression designated by the target impression designation module 204 with the estimated impressions associated with the plurality of pieces of poster data obtained from the impression estimation module 218, and calculates impression evaluation values. Also, the evaluation value calculation module 222 compares the target quality designated by the target quality designation module 220 with the estimated quality associated with the plurality of pieces of poster data obtained from the quality estimation module 221, and calculates quality evaluation values. Then, the evaluation value calculation module 222 calculates an overall evaluation value for selecting poster data, based on the impression evaluation values and the quality evaluation values. The evaluation value calculation module 222 outputs the overall evaluation value calculated in this way to the poster selection module 219.

The poster selection module 219 selects the poster data associated with the smallest overall evaluation value, that is, the evaluation value with the highest evaluation, among the overall evaluation values obtained from the evaluation value calculation module 222. The selection result is stored in the HDD 104. The poster selection module 219 outputs the selected poster data to the poster display module 205. The poster display module 205 outputs a poster image to be displayed on the display 105 according to the poster data obtained from the poster selection module 219. The poster image is bitmap data, for example. The poster display module 205 displays a poster image on the display 105.

Note that the poster creation application may also include a function (not shown) that enables the user to edit the arrangement, color, shape, and the like of the images, text, and graphics through an additional user operation after the generated result is displayed in the poster display module 205, and further change the design of the poster to the user's desired design.

Also, if a function for printing the poster data stored in the HDD 104 with a printer according to conditions designated in the poster generating condition designation module 201 is provided, the user will be able to obtain a printed copy of the created poster.

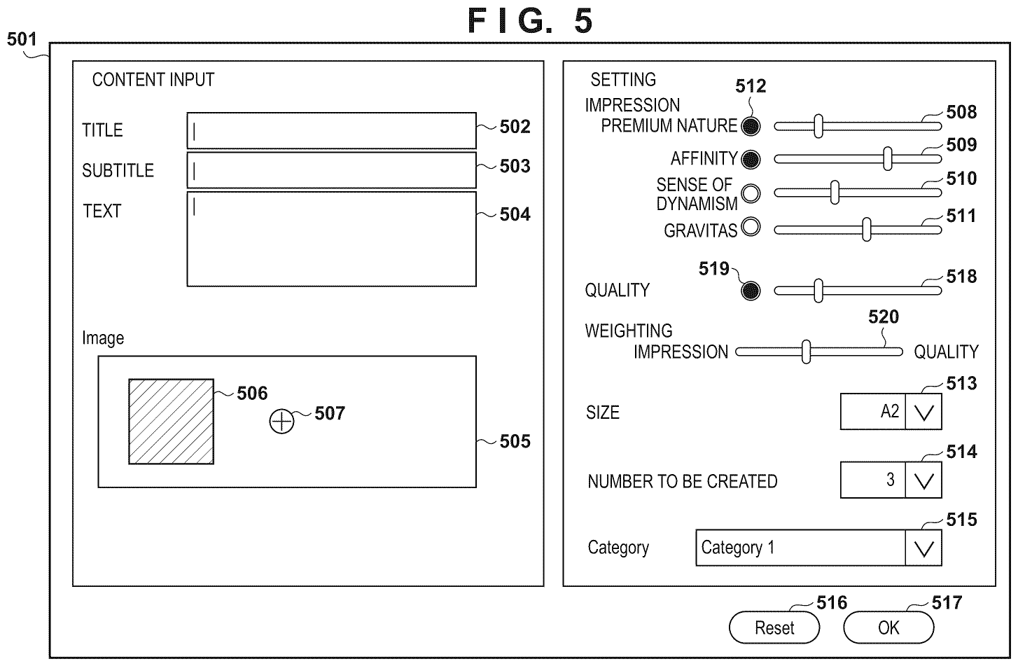

FIG. 5 is a diagram showing an example of an application start-up screen 501 provided by the poster creation application according to the first embodiment.

The application start-up screen 501 is displayed on the display 105. The user sets the creation conditions, text, and image of the poster, which will be described later, via the application start-up screen 501. The poster generating condition designation module 201, the image specifying module 203, and the text specifying module 202 obtain settings from the user via this UI screen.

A title box 502, a subtitle box 503, and a main text box 504 receive designation of character information to be arranged on a poster. Note that in the first embodiment, three types of character information are received, but there is no limitation to this. For example, character information such as a location or a date and time may be additionally accepted. Also, it is not necessary for all designations to be complete, and some boxes may be left blank.

An image designation area 505 is an area for displaying an image to be arranged on the poster. An image 506 represents a thumbnail of the specified image. An add image button 507 is a button for adding an image to be arranged on the poster. When the user presses the add image button 507, the image specifying module 203 displays a dialogue screen for selecting a file stored in the HDD 104 and receives the selection of the image file by the user. A thumbnail of the selected image is then added to the image designation area 505.

Impression sliders 508 to 511 are objects for setting factors of the target impression of the poster to be created. For example, the slider 508 is a slider for setting a target impression factor related to a premium nature, and the target impression is set such that the more the slider 508 is slid to the right, the higher the premium nature is, and the more the slider 508 is slid to the left, the lower the premium nature is (the cheaper the poster is). Also, by combining the factors of the target impression set with the respective sliders, a target impression is set that reflects not only a factor of the target impression set with one slider, but also the factors of the target impression set with the other sliders. For example, it is assumed that a user operation is performed on the screen of the poster generation application, the impression slider 508 is set to the right of the center of the slider, and the impression slider 511 is set to the left of the center of the slider. In this case, a poster is generated that gives an elegant impression, with a high premium nature and a low degree of gravitas. Also, for example, it is assumed that the user has set the impression slider 508 to the right of the center of the slider, and set the impression slider 511 to the right of the center of the slider. In this case, a poster is generated that gives a gorgeous impression, with both a high premium nature and a high degree of gravitas. In this way, by combining the factors of the target impression indicated by a plurality of impression sliders, even if a factor of the target impression that is held in common, that is, a “premium nature”, is set, it is possible to set target impressions with different directions, such as an “elegant” target impression and a “gorgeous” target impression. That is, the target impression includes and is determined by a plurality of factors indicating a degree of impression, but may also be determined by a single factor indicating a degree of impression.

In the first embodiment, the leftmost position of the slider is −2, the rightmost position is +2, and correction is performed to an integer value between −2 and +2. These numerical values indicate that, regarding the degree of impression, −2 is low, −1 is somewhat low, 0 is neutral, +1 is somewhat high, and +2 is high. Note that the purpose of correcting to values between −2 and +2 is to match the scale with the estimated impression to facilitate a later-described distance calculation, but there is no limitation to this, and it is also possible to perform normalization using values between 0 and 1.

The impression radio buttons 512 are buttons that can control whether the setting for each target impression is enabled or disabled. The user can set whether to enable or disable the setting for each target impression by pressing an impression radio button 512 to set it to an on or off state. For example, when an impression radio button 512 is turned off, the factor of impression corresponding to the radio button is excluded from impression control. For example, a user who wants to create a calm poster with a low degree of dynamism but has no particular specifications for other impression factors can generate a poster that specializes in a low degree of dynamism by turning off the impression radio buttons 512 other than that for degree of dynamism. Note that FIG. 5 shows a state in which premium nature and affinity are turned on, and degree of dynamism and gravitas are turned off. This enables highly flexible control, such as using all target impressions for poster generation or using only some of the target impressions for poster generation. Note that if the case where each slider is set to the leftmost position is the same as the case where each target impression is not set (e.g., the case where the premium nature is 0 when the slider 508 is set to the leftmost position), the impression radio buttons 512 may be omitted. In this case, if the user wants to disable the setting of the target impression, the user can disable the setting of the target impression by setting the slider to the leftmost position.

A quality slider 518 is an object for setting the target quality to be achieved in the poster to be created. For example, the target quality is set such that the quality is higher the further to the right the slider 518 is slid, and the quality is lower the further to left the slider 518 is slid. In the first embodiment, the leftmost position of the slider 518 is set to +1, the rightmost position is set to +5, and correction is performed to an integer value between +1 and +5. These numeric values indicate that, regarding the quality, +1 is low, +2 is somewhat low, +3 is neutral, +4 is somewhat high, and +5 is high. Note that the purpose of correcting to values between +1 and +5 is to match the scale with an estimated quality to facilitate a later-described distance calculation, but there is no limitation thereto, and it is also possible to perform normalization using values between 0 and 1. A quality radio button 519 is a button that can control whether the setting of the target quality is enabled or disabled. The user can set whether to enable or disable the setting of the target quality by pressing the quality radio button 519 to set it to an on or off state. For example, when the quality radio button 519 is turned off, quality is excluded from control of generating a poster. For example, a user who does not care about the quality and wants to emphasize expressing the target impression can generate a poster specialized in expressing the target impression by turning off the quality radio button 519. Note that if the case where the quality slider 518 is set to the leftmost position is the same as the case where the target quality is not set, the quality radio button 519 may be omitted. In this case, if the user wishes to disable the setting of the target quality, the user can disable the target quality setting by setting the slider 518 to the leftmost position. Also, the quality slider 518 and the quality radio button 519 may be omitted. In this case, the target quality is set to a predetermined value. As described later, since quality is a user-independent evaluation axis in which higher quality is more likely to be accepted, it is also possible to internally designate the target quality.

A weighting slider 520 is an object for setting weighting indicating the degree of balance between emphasizing the target impression specified by the impression sliders 508 to 511 and emphasizing the target quality specified by the quality slider 518. For example, generation of the poster is controlled with more emphasis on the target impression the further to the left the weighting slider 520 is slid, and more emphasis on the target quality the further to the right the weighting slider 520 is slid. When the weighting slider 520 is at the center position, generation of the poster is controlled with emphasis on the target impression and the target quality at a 1:1 ratio. In the first embodiment, the weighting slider 520 is set to 0.0 when it is set to the leftmost position and 1.0 when it is set to the rightmost position, and correction is performed to a decimal value between 0.0 and 1.0. For example, these numerical values (weighting information) are values where 0.0 indicates that emphasis is given to only the target impression, 0.5 indicates that equal emphasis is given to the target impression and the target quality, and 1.0 indicates that that emphasis is given to only the target quality.

A size list box 513 is a list box for setting the size of the poster to be created. Due to the user clicking with the pointing device 107, a list of poster sizes that can be created is displayed, and a selection can be made. In a creation number box 514, the number of candidates for posters to be created can be set. A category list box 515 allows the user to set the use category of the poster to be created. A reset button 516 is a button for resetting each piece of setting information on the application start-up screen 501.

When the user presses the OK button 517, the poster generating condition designation module 201, the text specifying module 202, the image specifying module 203, the target impression designation module 204, the target quality designation module 220, and the weighting designation module 223 output the contents set on the application start-up screen 501 to the poster generation module 210. At this time, the poster generating condition designation module 201 obtains the size of the poster to be created from the size list box 513, the number of posters to be created from the creation number box 514, and the use category of the poster to be created from the category list box 515. The text specifying module 202 obtains character information to be arranged on the poster from the title box 502, the subtitle box 503, and the main text box 504. The image specifying module 203 obtains the file path of the image to be arranged on the poster from the image designation area 505. The target impression designation module 204 obtains the target impression of the poster to be created from the impression sliders 508 to 511 and the impression radio button 512. The target quality designation module 220 obtains the target quality of the poster to be created from the quality slider 518 and the quality radio button 519. The weighting designation module 223 obtains weighting that emphasizes the target impression and the target quality from the weighting slider 520. Note that the poster generating condition designation module 201, the text specifying module 202, the image specifying module 203, the target impression designation module 204, the target quality designation module 220 and the weighting designation module 223 may also process the values set on the application start-up screen 501. For example, the text specifying module 202 may remove unnecessary white space characters at the beginning or end of the input character information. The target impression designation module 204 may also correct the values of the target impression specified by the impression sliders 508 to 511. The target quality designation module 220 may also correct the value of the target quality specified by the quality slider 518. The weighting designation module 223 may also correct the weighting value designated by the weighting slider 520.

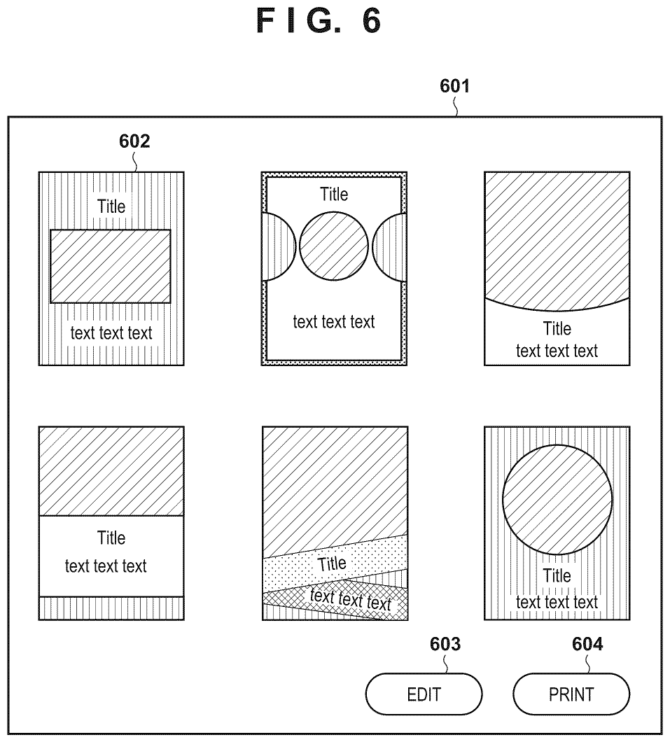

FIG. 6 is a diagram showing an example of a poster preview screen 601 displayed by the poster display module 205 in the first embodiment. When the OK button 517 on the application start-up screen 501 in FIG. 5 is pressed and the generation of the poster image is completed, the screen transitions to this poster preview screen 601.

A poster image 602 is a poster image output by the poster display module 205. The poster generation module 210 generates the number of posters designated by the poster generating condition designation module 201 or more, and the generated posters are displayed as a list as the poster images 602 on the poster preview screen 601. When the user clicks on a poster image in this list with the pointing device 107, that poster image is selected. An edit button 603 allows the selected poster image to be edited through a UI that provides an editing function (not shown). A print button 604 allows the selected poster image to be printed via a printer control UI (not shown).

### Quantifying Impression of Poster

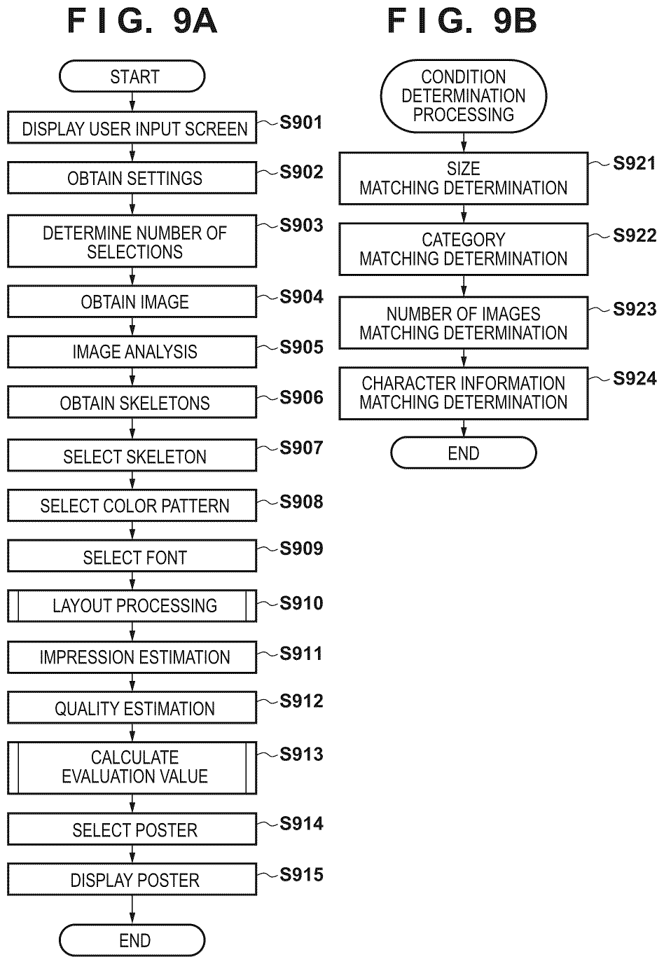

Here, a method of processing for quantifying a degree of impression of a poster image, which is pre-processing for executing impression estimation processing described later in step S911 of FIG. 9A and is required for poster generation processing, will be described. Processing for quantifying the degree of impression given by a poster is performed by a vendor or the like who develops the poster creation application during the development stage of the poster creation application. Note that processing for quantifying the degree of impression given by the poster image may be executed by the poster generation apparatus 100 or by an information processing apparatus different from the poster generation apparatus 100. Note that when this processing is executed by an information processing apparatus other than the poster generation apparatus 100, the processing is executed by the CPU of that information processing apparatus.

In the processing for quantifying the degree of impression given by a poster, the degree of impression that a person has of various posters is quantified. At the same time, a correspondence relationship between the poster image and the degree of impression given by the poster is calculated. This makes it possible to estimate the degree of impression given by the poster from the generated poster image. If the degree of impression can be estimated, it is possible to control the impression given by a poster by retouching the poster image, or to search for a poster image that gives a certain target impression. Note that the impression quantification processing of the poster is executed, for example, in the poster generation apparatus 100 by running an impression learning application for learning the degree of impression given by the poster image in advance prior to the poster generation processing.

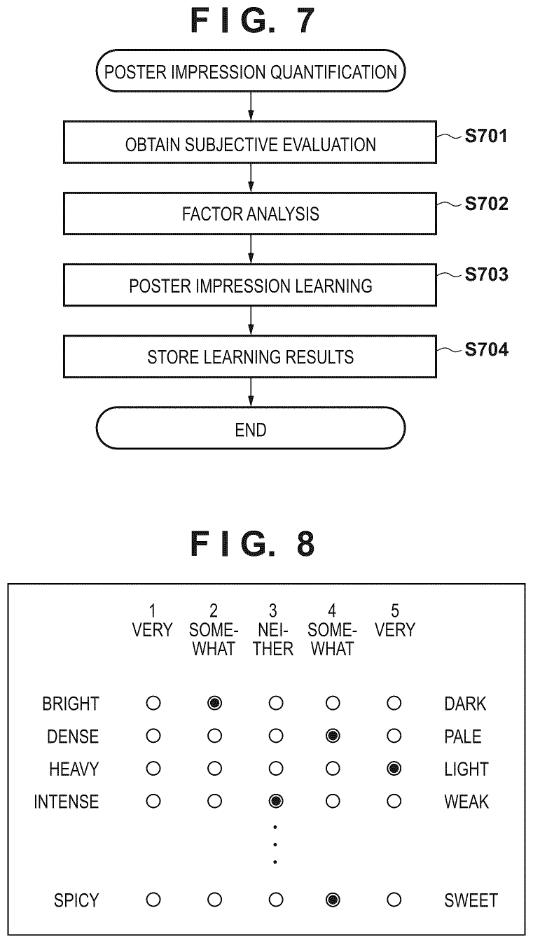

FIG. 7 is a flowchart for describing the impression quantification processing of a poster executed by the poster generation apparatus 100 according to the first embodiment. The processing shown in the flowchart of FIG. 7 is realized, for example, by the CPU 101 deploying a program stored in the HDD 104 to the RAM 103 and executing the program. Hereinafter, the impression quantification processing of the poster according to the first embodiment will be described with reference to FIG. 7. Note that the symbol “S” in the description of each process shown in FIG. 7 means a step in the flowchart (the same applies hereinafter in this specification).

In step S701, the CPU 101 obtains a subjective evaluation of a degree of impression of a poster.

FIG. 8 is a diagram for describing an example of a subjective evaluation method for a degree of impression of a poster.

Here, a poster is presented to a test subject, and the CPU 101 obtains a subjective evaluation of the degree of impression given by the poster based on a response from the test subject. In this case, measurement methods such as the semantic differential (SD) method and the Likert scale method can be used. FIG. 8 shows an example of the results of a questionnaire using the SD method. Here, an example of a questionnaire is shown in which adjective pairs expressing degrees of impressions (bright and dark, dense and light, etc.) are presented to a plurality of evaluators and the subjective evaluation results are scored regarding the adjective pairs that are evoked by the target poster. After obtaining subjective evaluation results from a plurality of test subjects for a plurality of posters, the CPU 101 calculates an average value of the responses to each adjective pair and sets the average value as a representative score value for the corresponding adjective pair. Note that the subjective evaluation method for the degree of impression may be a method other than the SD method, as long as words expressing degrees of impressions and scores corresponding thereto are determined.

Next, the processing advances to step S702, and the CPU 101 executes factor analysis of the subjective evaluation results obtained in step S701. If the subjective evaluation results are used as-is, the number of adjective pairs will be the number of dimensions and control will be complicated, and therefore it is desirable to reduce the number of dimensions to an efficient level using an analytical method such as factor analysis. In the first embodiment, it is assumed that the dimensions are reduced to four factors through factor analysis. Naturally, this number varies depending on the choice of adjective pairs in the subjective evaluation. Also, the output of the factor analysis is assumed to be standardized. That is, each factor is scaled to have a mean of 0 and a variance of 1 for the posters used in the analysis. This allows the values −2, −1, 0, +1, and +2 of the impressions specified in the target impression designation module 204 to directly correspond to −20, −10, the mean value, +10, and +20 in each impression, making it easier to perform the later-described distance calculation between the target impression and the estimated impression. Note that in the first embodiment, the four factors shown in FIG. 5 are premium nature, affinity, dynamism, and gravitas, but these are names given for the sake of convenience in order to provide impressions to the user through the user interface, and each factor is constituted by a plurality of adjective pairs that influence each other.

Next, the processing advances to step S703, and the CPU 101 associates the poster image with the degree of impression. Although it is possible to quantify the posters that have been subjectively evaluated using the method described above, it is also necessary to estimate the degrees of impressions of posters to be created in the future without subjective evaluation. Association of poster images with the degrees of impressions can be achieved by training a model that estimates the degrees of impressions from poster images using, for example, a deep learning method based on convolution neural network (CNN), a machine learning method using decision trees, or the like. In the first embodiment, the impression learning means performs supervised deep learning using CNN with a poster image as input and four factors as output. That is, a deep learning model is created by learning the subjectively evaluated poster images and their corresponding degrees of impressions as correct answers, and an unknown poster image is input into the learning model to estimate the degree of impression.

Next, the processing advances to step S704, and the CPU 101 stores, in the HDD 104, the model configuration and learned parameters of the deep learning model for impression estimation created in step S703.

Note that the deep learning model created above is stored, for example, in the HDD 104, and the impression estimation module 218 deploys the deep learning model for impression estimation stored in the HDD 104 to the RAM 103 and executes it. The impression estimation module 218 converts the poster data obtained from the layout module 217 into an image and estimates the degree of impression given by the poster by running the deep learning model deployed to the RAM 103 on the CPU 101 or a GPU (not shown). Note that in the first embodiment, a deep learning method is used, but the present invention is not limited to this. For example, when using a machine learning method such as a decision tree, feature amounts such as the average brightness value and edge amount of the poster image may be extracted through image analysis, and a machine learning model that estimates the degree of impression based on the feature amounts may be created.

### Quantifying Quality of Poster

Here, a method for quantifying the quality of a poster, which is pre-processing for executing the quality estimation processing described later in step S912 of FIG. 9A and is necessary for poster generation processing, will be described. The processing for quantifying the quality of a poster is performed by a vendor or the like who develops the poster creation application during the development stage of the poster creation application. Note that the processing for quantifying the quality of a poster may be executed by the poster generation apparatus 100 or by an information processing apparatus different from the poster generation apparatus 100. Note that when the processing is executed by an information processing apparatus different from the poster generation apparatus 100, the processing is executed by the CPU of the information processing apparatus.

The processing for quantifying the quality of a poster involves quantifying the quality that people perceive for various posters. At the same time, a correspondence relationship between the poster image and the quality of the poster is calculated. This makes it possible to estimate the quality of the poster from the generated poster image. If the quality of a poster can be estimated, it is possible to control the quality of the poster by retouching the poster image based on the estimated quality, or to search for a poster image with a certain target quality. Note that the poster quality quantification processing is executed in the poster generation apparatus 100, for example, by running a quality learning application for learning the quality of the poster image in advance prior to the poster generation processing.

FIG. 17 is a flowchart for describing poster quality quantification processing according to the first embodiment. The flowchart shown in FIG. 17 is realized, for example, by the CPU 101 deploying a program stored in the HDD 104 to the RAM 103 and executing the program. The poster quality quantification processing will be described below with reference to FIG. 17.

In step S1701, the CPU 101 obtains a subjective evaluation of the quality of a poster.

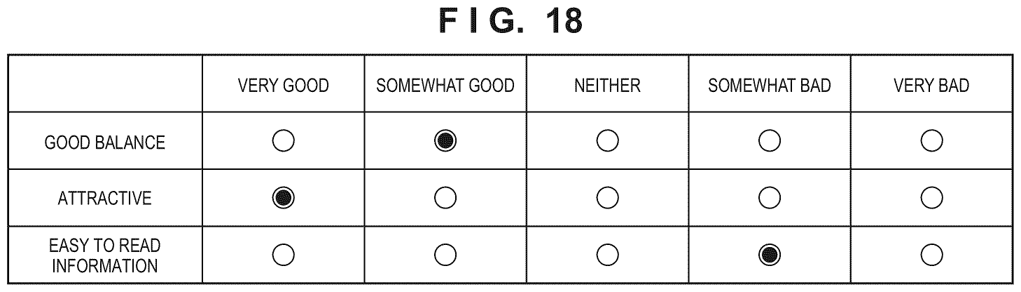

FIG. 18 is a diagram for describing an example of a subjective evaluation method for the quality of a poster.

The CPU 101 presents a poster to test subjects (evaluators) and obtains a subjective evaluation of the quality of the poster from the test subjects. At this time, a measurement method such as the semantic differential (SD) method or the Likert scale method can be used. FIG. 18 shows an example of a questionnaire using the Likert scale method, in which evaluation items that influence quality are presented to a plurality of evaluators and a score is assigned to each evaluation item of the target posters. After obtaining subjective evaluation results from a plurality of test subjects for a plurality of posters, the CPU 101 calculates an average value of the responses for each evaluation item and sets the average value as a representative score value for the corresponding evaluation item. Note that the subjective evaluation method for quality may be a method other than the Likert scale method, as long as the items for evaluating the quality and the corresponding scores are determined.

Next, the processing advances to step S1702, and the CPU 101 executes main component analysis of the subjective evaluation results obtained in step S1701. If the subjective evaluation results are used as-is, the number of evaluation items will be the number of dimensions and control will be complicated, and therefore it is desirable to reduce the number of dimensions to an efficient level using an analytical method such as main component analysis. In the first embodiment, description will be given assuming that a plurality of evaluation items are summarized into one main component through the main component analysis, and the quality is evaluated comprehensively. Also, the output of the main component analysis is assumed to be normalized. That is, the summarized main component is scaled, for example, to have a minimum of 1 and a maximum of 5 in the posters used in the analysis. This allows +1, +2, +3, +4, and +5 of the quality designated in the target quality designation module 220 to directly correspond to +1, +2, +3, +4, and +5 of the quality, making it easier to perform later-described distance calculation between the target quality and the estimated quality.

Next, the processing advances to step S1703, and the CPU 101 associates the poster image with the quality. Although it is possible to quantify posters that have been subjectively evaluated using the method described above, it is also necessary to estimate the quality of posters to be created in the future without subjective evaluation. Association of poster images with quality can be achieved by training a model that estimates quality from poster images using, for example, a deep learning method such as convolution neural network (CNN) or a machine learning method using decision trees. In the first embodiment, the quality learning means performs supervised deep learning using CNN, with a poster image as input and a single evaluation value as output. That is, a deep learning model is created by learning the subjectively evaluated poster images and their corresponding qualities as correct answers, and unknown poster images are input into the learning model to estimate their quality.

The processing then advances to step S1704, and the CPU 101 stores, in the HDD 104, the model configuration and learned parameters of the deep learning model for quality estimation created in step S1703.

Note that the quality estimation module 221 deploys the deep learning model for quality estimation stored in the HIDD 104 to the RAM 103 and executes it. The quality estimation module 221 converts the poster data obtained from the layout module 217 into an image and estimates the quality of the poster by running the deep learning model deployed to the RAM 103 on the CPU 101 or the GPU. Note that although the deep learning method is used in the first embodiment, the present invention is not limited thereto. For example, when using a machine learning method such as a decision tree, feature amounts such as the blank space ratio and the pure color ratio of the poster image may be extracted through image analysis, and a machine learning model that estimates quality based on those feature amounts may be created.

Also, feature amounts may be extracted from un-rendered poster data instead of the poster image, and a machine learning model may be created that estimates quality based on the feature amounts. For example, the center of gravity position and the blank space ratio are calculated to estimate the balance of a design. Note that rendering processing is processing for converting poster data into image data.

When creating a machine learning model that estimates quality based on feature amounts, it is desirable to use feature amounts of a type that influences the quality of the poster. For example, the quality of a poster is affected by factors such as balance, noticeability, and visibility of the design. Examples of feature amounts relating to balance include the center of gravity position and the blank space ratio. If the center of gravity in a poster is too far off center, the design will look silly. The center of gravity position is obtained by converting the poster data into a luminance image and calculating the center of gravity position. If there is not enough blank space in a poster, the design will be cramped with too much information. The blank space ratio is obtained by extracting the edges of the poster image, performing certain expansion processing, and then calculating the ratio of pixels whose pixel value remains 0 to the total number of pixels. Examples of feature amounts relating to noticeability include the jump ratio of the font size and the arrangement distribution of objects. The jump ratio is the ratio between the sizes of large elements and small elements, and a high jump ratio makes important information more noticeable in a design. The jump ratio of the font size is obtained by calculating the ratio between the maximum character size in the poster data and the average value of all character sizes. In a poster, if all of the elements such as photographs and characters are lined up in a vertical row in the center with little distribution, the design will be orderly, static, and less noticeable. The arrangement distribution is obtained by calculating the variance of the positions at which the objects are arranged in the poster data. Examples of feature amounts relating to visibility include the pure color ratio and the type of font for the main text. A pure color is a color with high brightness and saturation, and it is thought that if many pure colors are used in a poster, it will be glaringly bright and difficult to read, and will put strain on the eyes. The pure color ratio is obtained by converting the poster image into an HSV color space and calculating the ratio of pixels with a saturation S and brightness V of a certain level or higher to the total number of pixels. For the main text of a poster, which contains detailed information, it is recommended to use fonts such as Gothic or Mincho, which emphasize readability over noticeability. The type of font for the main text is obtained by determining whether the font assigned to the character object for which “main text” has been designated in the poster data is Gothic or Mincho. Note that the types and calculation methods of feature amounts that influence quality are not limited to those described above.

Difference between Impression and Quality

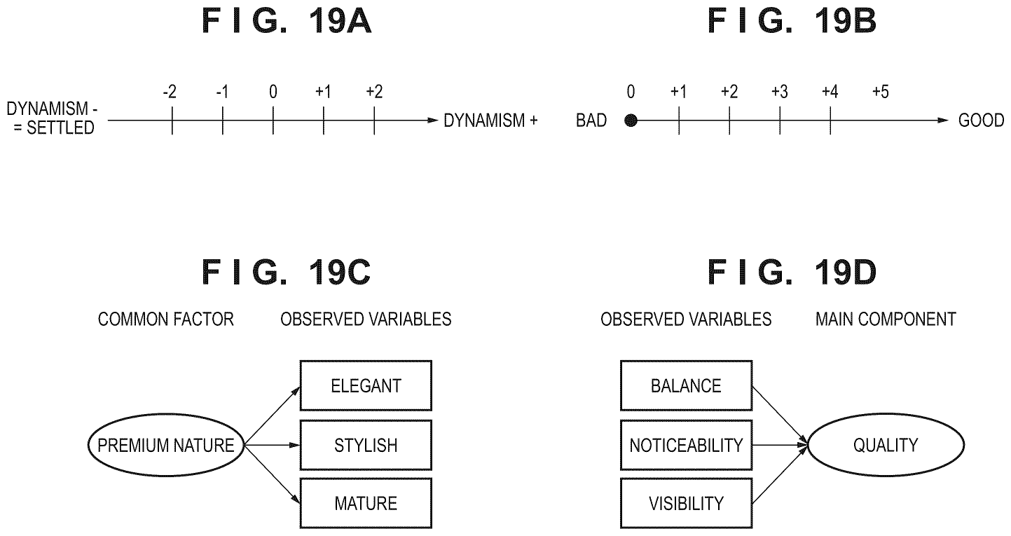

Learning of both a degree of impression and quality is performed through a flow in which subjective evaluation results are analyzed and the relationship between posters and analysis results are learned using a machine learning model, but a degree of impression and quality are different in nature, as will be described with reference to FIG. 19.

FIGS. 19A to 19D are diagrams for describing the difference between a degree of impression and quality. The degree of impression and quality have different characteristics, and as shown in FIG. 19A, a degree of impression is a concept expressed by direction and intensity. For example, an intensity of +2 in the direction of the degree of dynamism that one is caused to feel a strong degree of dynamism, while an intensity of −2 in the direction of degree of dynamism means that one is caused to feel a strong impression of calm, which is the opposite of dynamism. There are no set indicators for the direction and intensity to aim for in a degree of impression, and the degree of impression intended by the user will be the correct answer for that user. That is, the degree of impression is a user-dependent evaluation axis.

In contrast, as shown in FIG. 19B, quality is a concept expressed by how good or bad the design is. For example, a poster with a sophisticated design, such as one created by a professional designer, can be said to be of high quality, while a poster that is unbalanced and lacks any eye-catching elements can be said to be of low quality. Since higher quality is more acceptable to all users, the concept of quality itself is a user-independent evaluation axis. However, since the extent to which quality is acceptable is dependent on the user, in the first embodiment, the acceptable range of quality can be designated with the quality slider 518 shown in FIG. 5. In this way, the degree of impression is a user-independent evaluation axis expressed by direction and intensity, while the quality is a user-dependent evaluation axis expressed by good or bad, and the two have different characteristics.

Also, there is a difference in the positioning of s degree of impression and quality, and therefore there is a difference in the methods for analyzing the subjective evaluation results. As shown in FIG. 19C, impression is a common factor that influences various feelings. For example, if a poster gives the impression of a premium nature, it evokes feelings such as “elegant”, “stylish”, and “mature”. That is, the impression of a premium nature is the common factor, and feelings such as “elegant”, “stylish”, and “mature” are the observed variables. For this reason, when quantifying degrees of impressions, subjective evaluations of adjectives that express various feelings are obtained, and the degree of impression that is the common factor is obtained through factor analysis.

In contrast, as shown in FIG. 19D, quality is a main component that comprehensively represents various evaluation items. For example, if a poster has a well-balanced, eye-catching (attractive) design that is easy to see and read (visible), the overall quality of the poster can be said to be high. In other words, evaluation items such as “well-balanced”, “eye-catching”, and “easy to see and read” are observed variables, and “quality,” which is the integration of these, is the main component. For this reason, when quantifying quality, evaluations for various evaluation items are obtained through subjective evaluation, and then quality, which is the main component, is obtained through main component analysis. In this way, a degree of impression is a common factor shared by various feelings obtained through factor analysis, while quality is a main component that integrates various evaluation items obtained through main component analysis, and thus the two have different positioning. Accordingly, the degree of impression and the quality are concepts with mutually different characteristics and therefore need to be used as different control axes.

### Poster Generation Processing

FIG. 9A is a flowchart for describing poster generation processing performed by the poster generation module 210 of the poster creation application according to the first embodiment. As described above, the flowchart shown in FIG. 9A starts when the user sets various setting items on the poster creation application and presses the OK button 517. Note that the processing shown in this flowchart is realized, for example, by the CPU 101 deploying a program stored in the HDD 104 to the RAM 103 and executing the program. In the first embodiment, the CPU 101 functions by executing the above-mentioned poster creation application, and therefore the constituent elements shown in FIG. 2 will be described as executing the processing shown in this flowchart.

In step S901, the CPU 101 displays the application start-up screen 501 on the display 105. The user inputs each setting via the UI screen of the application start-up screen 501 using the keyboard 106 or the pointing device 107. Next, the processing advances to step S902, and the poster generating condition designation module 201, the text specifying module 202, the image specifying module 203, and the target impression designation module 204 obtain the corresponding settings from the application start-up screen 501. Then, the processing advances to step S903, and the skeleton selection module 214, the color pattern selection module 215, and the font selection module 216 respectively determine the number of skeletons, the number of color patterns, and the number of fonts to be selected according to the number of posters to be created, which was designated by the poster generating condition designation module 201. In the first embodiment, the layout module 217 generates pieces of poster data, the number of which is (number of skeletons) x (number of color patterns)× (number of fonts), using a later-described method. At this time, the number of skeletons, the number of color patterns, and the number of fonts to be selected are determined such that the number of posters to be generated exceeds the number to of posters to be created. In the first embodiment, the number of skeletons, the number of color patterns, and the number of fonts are each determined according to the following Equation (1).

$$Number of selections = {\vert}^{3} √ \{ ( number of posters to be created ) \times 2 \} \vert \qquad Equation ( 1 )$$

Here, the symbol “|x|” indicates a ceiling function, and is expressed as an integer value by rounding up the decimal point of x. For example, if the number of posters to be created is 6, the number of selections is 3, the number of pieces of poster data generated by the layout module 217 is 27, and the poster selection module 219 selects 6 pieces of poster data from among them. This allows the poster selection module 219 to select a poster whose overall impression is closest to the target impression from among the pieces of poster data generated at or above the number of posters created.

Next, the processing advances to step S904, and the image obtaining module 211 obtains image data. Specifically, the image obtaining module 211 reads out an image file in the HDD 104 that is specified by the image specifying module 203 to store image data into the RAM 103.

Next, the processing advances to step S905, and the image analyzing module 212 executes analysis processing on the image data obtained in step S904, and obtains information indicating feature amounts. Examples of information indicating this feature amount include meta information stored in the image and information indicating an image feature quantity that can be obtained by analyzing the image. These pieces of information are used in object recognition processing, which is analysis processing. Note that in the first embodiment, the analysis processing is object recognition processing, but there is no limitation thereto, and other analysis processing may be executed. Furthermore, the processing of step S905 may be omitted. The processing performed by the image analyzing module 212 in step S905 will be described in detail below.

The image analyzing module 212 executes object recognition processing on the image data obtained in step S904. Here, a known method can be used for the object recognition processing. In the first embodiment, objects are recognized using a classifier created through Deep Learning. The classifier outputs a value between 0 and 1 indicating the likelihood that a certain pixel in the image data is a pixel that makes up an object, and recognizes that an object that exceeds a certain threshold is present in the image data. The image analyzing module 212 can obtain the type and position of an object, such as a face, a pet such as a dog or a cat, a flower, food, a building, an ornament, or a landmark, by recognizing the object image.

Next, the processing advances to step S906, and the skeleton obtaining module 213 obtains skeletons that meet the various setting conditions. In the first embodiment, it is assumed that the skeletons are stored in the HDD 104 with one file per skeleton. The skeleton obtaining module 213 sequentially reads skeleton files from the HDD 104 into the RAM 103, leaves skeletons that meet the setting conditions on the RAM 103, and deletes skeletons that do not meet the conditions from the RAM 103.

FIG. 9B is a flowchart for describing condition determination processing for the skeleton obtaining module 213 according to the first embodiment to select a skeleton that meets the setting conditions.

In step S921, for the skeletons loaded into the RAM 103, the skeleton obtaining module 213 determines whether the poster size designated by the poster generating condition designation module 201 matches the skeleton size. Note that although it is confirmed here that the sizes match, it is also sufficient that only the aspect ratios match. In this case, the skeleton obtaining module 213 obtains a skeleton that matches the poster size designated by the poster generating condition designation module 201 by enlarging or shrinking the coordinate system of the loaded skeleton.

Next, the processing advances to step S922, and the skeleton obtaining module 213 determines whether the use category designated in the poster generating condition designation module 201 matches the category of the skeleton. For a skeleton that is used only for a specific purpose, a use category is specified in the skeleton file, and thus the skeleton is not obtained unless the corresponding use category is selected. This is done to prevent the skeleton from being used in other use categories when it is designed for a specific purpose, such as when the skeleton has a graphic depicting a pattern inspired by a school or sporting goods, for example. Note that if the use category is not set on the application start-up screen 501, step S922 is skipped.

Next, the processing advances to step S923, and the skeleton obtaining module 213 determines whether or not the number of image objects of the loaded skeleton matches the number of images obtained by the image obtaining module 211. Next, the processing advances to step S924, and the skeleton obtaining module 213 determines whether or not the character object of the loaded skeleton matches the character information specified by the text specifying module 202. More specifically, it is determined whether or not the type of character information specified in the text specifying module 202 is present in the skeleton. For example, it is assumed that character strings are specified in the title box 502 and the main text box 504 on the application start-up screen 501, and the subtitle box 503 is designated as a blank field. In this case, all character objects within the skeleton are searched, and if both a character object with “title” set as the type of character information in the metadata and a character object with “body” specified are found, it is deemed a match, and otherwise, it is deemed unsuitable.

As described above, the skeleton obtaining module 213 holds, in the RAM 103, skeletons whose skeleton size, use category, number of image objects, and type of character object all match the setting conditions. Note that in the first embodiment, the skeleton obtaining module 213 determines all skeleton files on the HDD 104, but the present invention is not limited thereto. For example, the poster creation application may hold, in the HDD 104, in advance, a database that associates file paths of skeleton files with search conditions (skeleton size, number of image objects, and type of character object). In this case, the skeleton obtaining module 213 can quickly obtain skeleton files by searching the database and reading out only the matching skeleton files from the HDD 104 to the RAM 103.

Next, the processing advances to step S907, and the skeleton selection module 214 selects a skeleton that matches the target impression specified by the target impression designation module 204 from among the skeletons obtained in step S906.

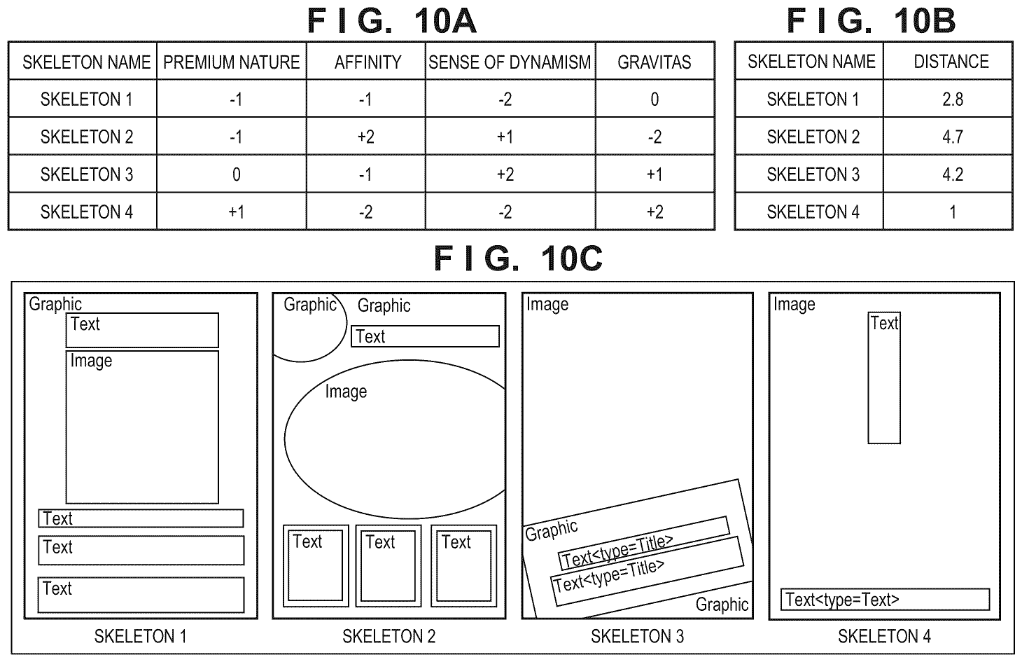

FIGS. 10A to 10C are diagrams for describing a method in which the skeleton selection module 214 according to the first embodiment selects skeletons. FIG. 10A shows an example of a skeleton impression table that associates skeletons and degrees of impressions. File names of the skeletons are written in the skeleton name column of FIG. 10A, and the premium nature, affinity, dynamism, and gravitas columns show numbers (numeric values) indicating the degree to which each skeleton influences each impression. These numeric values are values indicating that, regarding the degree of impression, −2 is low, −1 is somewhat low, 0 is neutral, +1 is somewhat high, and +2 is high.

First, the skeleton selection module 214 calculates the distance between the target impression obtained from the target impression designation module 204 and each degree of skeleton impression shown in the skeleton impression table of FIG. 10A. For example, if the target impression is “premium nature is +1, affinity is −1, degree of dynamism is −2, degree of gravitas is +2,” the distances calculated by the skeleton selection module 214 will be as shown in FIG. 10B. Note that in the first embodiment, the Euclidean distance is used as the distance (hereinafter, simple distance will be the Euclidean distance). The smaller the Euclidean distance, the closer the target impression is to the degree of skeleton impression. Next, the skeleton selection module 214 selects the top N skeletons having the smallest distance values in FIG. 10B. In the first embodiment, the skeleton selection module 214 selects the top two skeletons. That is, the skeleton selection module 214 selects skeleton 1 and skeleton 4.

Here, N may be set to a fixed value, or may be variable depending on the conditions designated in the poster generating condition designation module 201. For example, when the number of posters to be created is specified as 6 in the creation number box 514 on the application start-up screen 501, the poster generation module 210 generates six posters. A later-described layout module 217 combines the skeletons, color patterns, and fonts selected by the skeleton selection module 214, the color pattern selection module 215, and the font selection module 216 to generate a poster. For this reason, for example, by selecting two skeletons, two color patterns, and two fonts, 2×2×2-8 posters can be generated, satisfying the requirement of 6 posters. In this way, the number N of skeletons to be selected may be determined according to the conditions designated by the poster generating condition designation module 201.

Also, the value range of each degree of impression in the skeleton impression table of FIG. 10A does not need to be the same as the range of the degrees of impressions designated by the target impression designation module 204. In the first embodiment, the range of the degrees of impressions designated by the target impression designation module 204 is −2 to +2, but the range of the degrees of impressions in the skeleton impression table may be different from this. In this case, the above-mentioned distance calculation is performed after scaling the range of the skeleton impression table to match the range of the target impression. Also, the distance calculated by the skeleton selection module 214 is not limited to the Euclidean distance, but may be any distance between vectors, such as Manhattan distance or cosine similarity. Also, degrees of impressions for which the target impression has been set to off using the impression radio buttons 512 are excluded from distance calculation.

Also, the skeleton impression table is created in advance by fixing, for example, the color pattern, font, and images and character data to be arranged on the skeleton, generating a poster image based on each skeleton, and estimating the degree of impression thereof, and the skeleton impression table is stored in HDD 104. That is, by estimating the degrees of impressions of poster images that use the same character colors, images, and the like but have different arrangements of characters, images, and the like, the characteristics relative to other skeletons are made into a table. At this time, it is desirable to perform processing for cancelling degrees of impressions resulting from the color patterns and images used, such as by standardizing the entire estimated degrees of impressions or averaging the degrees of impressions of a plurality of poster images generated from one skeleton using a plurality of color patterns and images. As a result, the influence that the arrangement has on the degree of impression, such as the degree of impression of a skeleton with a small image being determined by elements such as graphics and characters rather than the image, or tilting of the arrangement of images and characters creating a stronger degree of dynamism, can be made into a table.

FIG. 10C shows an example of skeletons corresponding to skeleton 1 to skeleton 4 in FIG. 10A. For example, in skeleton 1, the image objects and character objects are arranged regularly and the image area is small, resulting in a low degree of dynamism. Skeleton 2 has a high affinity but a low degree of gravitas because the graphic object and image object are circular. Skeleton 3 not only has a large image object arranged therein, but also has a tilted graphic object arranged overlapping with the image object, resulting in an increased degree of dynamism. Skeleton 4 has an image arranged over the entire skeleton and has character objects kept to a minimum, resulting in an increased degree of gravitas but a reduced degree of dynamism. In this way, when a poster image includes characters or an image, poster images with different target impressions are generated depending on how the characters or images are arranged. Note that the method for creating the skeleton impression table is not limited to this, and it may be estimated from the characteristics of the layout information itself, such as the area and coordinates of the image and title character string, or may be adjusted manually. The skeleton impression table is stored in the HDD 104, and the skeleton selection module 214 reads the skeleton impression table from the HDD 104 to the RAM 103 for reference.

Next, the processing advances to step S908, and the color pattern selection module 215 selects a color pattern that matches the target impression designated by the target impression designation module 204. The color pattern selection module 215 refers to the impression table corresponding to the color pattern and selects a color pattern according to the target impression, using the same method as in step S906.

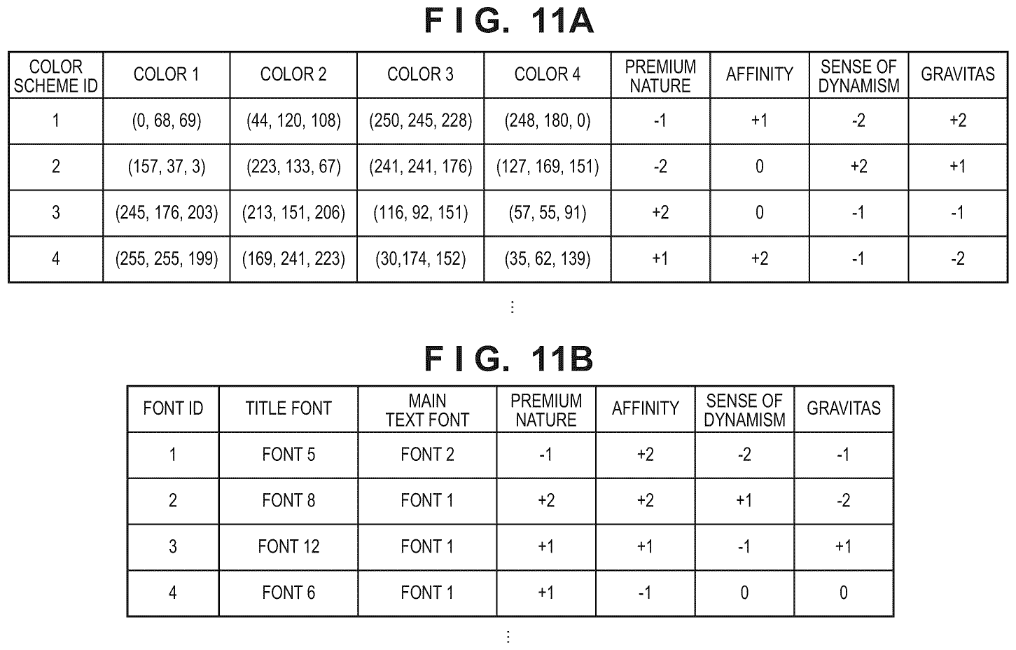

FIG. 11A shows an example of a color pattern impression table that associates color patterns with degrees of impressions. The color pattern selection module 215 calculates the values of the distances between the degrees of impressions shown in the premium nature column to the gravitas column in FIG. 11A and the target impression, and selects the top N color patterns with the smallest distance values. In the first embodiment, the top two color patterns are selected. Note that, similarly to the skeleton impression table, the color pattern impression table can be created by fixing the skeleton, font, and images other than the color pattern, and then creating posters with different color patterns and estimating the degrees of impressions thereof, thereby making the degree of impression trends of the color patterns into a table.

Next, the processing advances to step S909, and the font selection module 216 selects a font combination that matches the target impression designated by the target impression designation module 204. The font selection module 216 refers to the impression table corresponding to the font using the same method as in step S906, and selects a font according to the target impression.

FIG. 11B shows an example of a font impression table that associates fonts with degrees of impressions. The font selection module 216 calculates the values of the distances between the degrees of impressions indicated by the premium nature column to the gravitas column in FIG. 11B and the target impression, and selects the top N fonts with the smallest distance values. Note that similarly to the skeleton impression table, the font impression table can be created by fixing the skeleton, color pattern, and images other than the font, and then creating posters with different fonts and estimating the degrees of impressions thereof, thereby creating a table of the trend of the degrees of impressions of the fonts.

Next, the processing advances to step S910, and the layout module 217 sets the character information, the images, the color scheme, and the font for the skeleton selected by the skeleton selection module 214, and generates a poster.

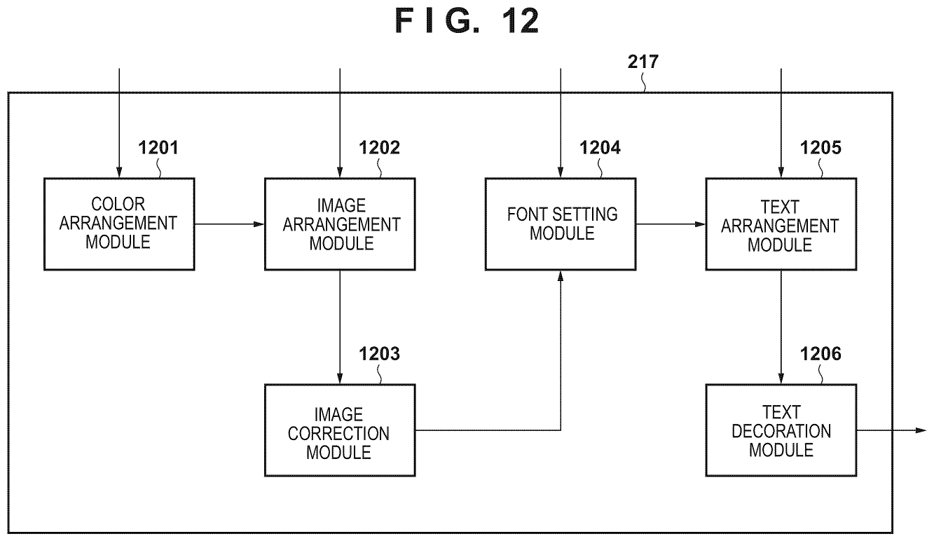

Next, processing in step S910 and the processing performed by the layout module 217 will be described in detail with reference to FIGS. 12, 13, 14A to 14C, and 15A to 15C.

FIG. 12 is a functional block diagram for describing the function of the layout module 217 according to the first embodiment.

The layout module 217 includes a color arrangement module 1201, an image arrangement module 1202, an image correction module 1203, a font setting module 1204, a text arrangement module 1205, and a text decoration module 1206.

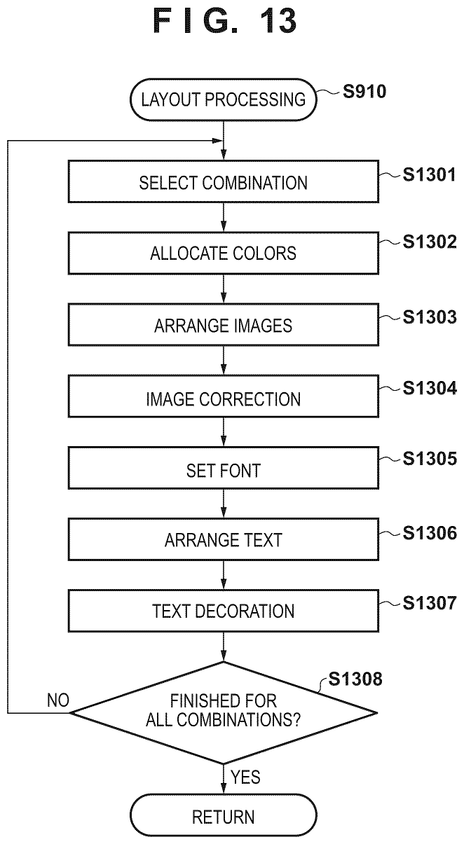

FIG. 13 is a flowchart for describing the layout processing in step S910 of FIG. 9A. The processing shown in this flowchart is realized, for example, by the CPU 101 deploying a program stored in the HDD 104 to the RAM 103 and executing the program. In the first embodiment, the CPU 101 functions by executing the above-described poster creation application, and therefore the constituent elements shown in FIG. 12 will be described as executing the processing shown in this flowchart.

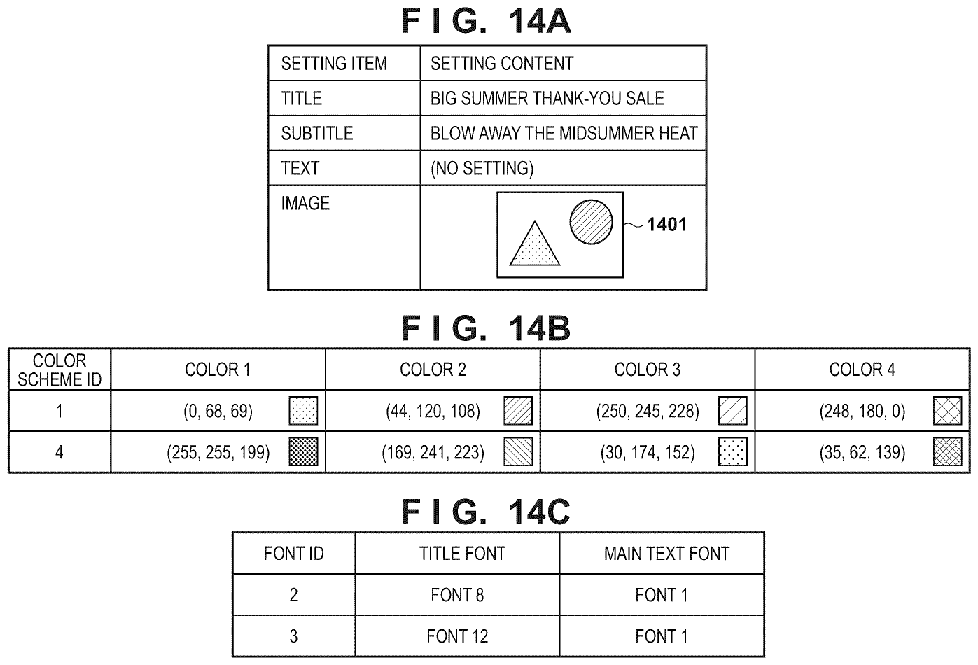

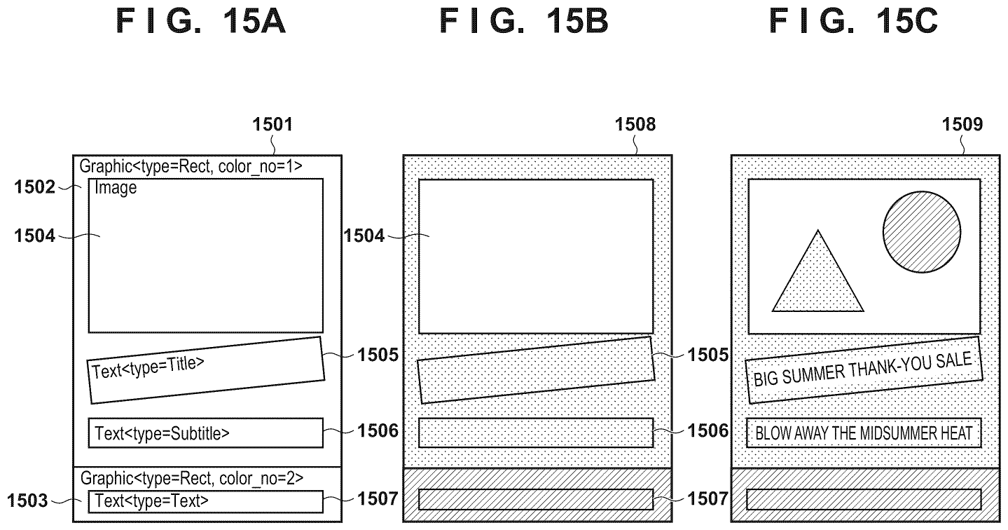

Also, FIGS. 14A to 14C are diagrams for describing the information input to the layout module 217, and FIG. 14A shows an example of a table summarizing the character information specified in the text specifying module 202 and the images specified in the image specifying module 203. FIG. 14B shows an example of a table showing color patterns obtained from the color pattern selection module 215, and FIG. 14C shows an example of a table showing fonts obtained from the font selection module 216. Furthermore, FIGS. 15A to 15C are diagrams for describing process of the processing performed by the layout module 217.

First, the layout processing in step S910 will be described in detail with reference to FIG. 13.

In step S1301, the layout module 217 lists all combinations of the skeletons obtained from the skeleton selection module 214, the color patterns obtained from the color pattern selection module 215, and the fonts obtained from the font selection module 216. The layout module 217 generates poster data for each combination in order through the following layout processing. For example, if the number of skeletons obtained from the skeleton selection module 214 is 3, the number of color patterns obtained from the color pattern selection module 215 is 2, and the number of fonts obtained from the font selection module 216 is 2, the layout module 217 generates 3×2×2-12 pieces of poster data. Then, in step S1301, the layout module 217 selects one combination from the listed combinations, and executes the processing of steps S1302 to S1307 on the selected combination.

Next, in step S1302, and the color arrangement module 1201 assigns the color pattern of the selected combination to the skeleton of the selected combination. FIG. 15A shows an example of a skeleton of the selected combination. In the first embodiment, an example will be described in which a color pattern with a color scheme ID of “1” in FIG. 14B is assigned to a skeleton 1501 in FIG. 15A.

The skeleton 1501 in FIG. 15A is constituted by two graphic objects 1502 and 1503, one image object 1504, and three character objects 1505, 1506, and 1507. First, the color arrangement module 1201 performs color arrangement for the graphic objects 1502 and 1503. Specifically, a corresponding color is assigned from the color pattern based on a color scheme number, which is metadata described in the graphic object. Next, the color arrangement module 1201 assigns, for example, the last color in the color pattern to character objects whose metadata is a type and whose attribute is “title” among the character objects. That is, in the first embodiment, a color 4 is assigned to the characters arranged in the character object 1505. Next, for characters arranged in a character object whose metadata is a type and whose attribute is not “title”, the character color is set based on the brightness of the background of that character object. In the first embodiment, if the brightness of the background of the character object is a threshold value or less, the character color is set to white, and if not, the character color is set to black. FIG. 15B is a diagram showing the state of the skeleton 1508 after the above-described color scheme assignment processing has been performed. The color arrangement module 1201 outputs the skeleton data subjected to color arrangement to the image arrangement module 1202.

Next, the processing advances to step S1303, and the image arrangement module 1202 arranges the image data obtained from the image analyzing module 212 on the skeleton data obtained from the color arrangement module 1201, based on the accompanying analysis information. In the first embodiment, the image arrangement module 1202 assigns the image data 1401 to the image object 1504 in the skeleton. Also, if the aspect ratios of the image object 1504 and the image data 1401 differ, the image arrangement module 1202 performs trimming such that the aspect ratio of the image data 1401 matches the aspect ratio of the image object 1504. More specifically, based on the position of the object obtained by the image analyzing module 212 analyzing the image data 1401, trimming is performed such that the object area reduced by the trimming is minimized. Note that the trimming method is not limited to this, and other trimming methods may be used, such as trimming the center of the image or devising the composition such that face positions form a triangular composition. The image arrangement module 1202 outputs the skeleton data to which the images have been assigned to the image correction module 1203.

Next, the processing advances to step S1304, and the image correction module 1203 obtains skeleton data to which images have been assigned from the image arrangement module 1202, and performs correction on the images arranged on the skeleton. In the first embodiment, if the image resolution is insufficient, upsampling processing is performed using super-resolution processing. First, the image correction module 1203 determines whether the image arranged on the skeleton fulfills a certain resolution. For example, it is assumed that an image of 1600 px×1200 px has been assigned to an area of 200 mm×150 mm on the skeleton. In this case, the print resolution of the image can be calculated using Equation 2.

$$( 1600 ) / ( 200 \div 25.4 ) \approx 203 ( dpi ) \qquad Equation ( 2 )$$

Next, if it is determined that the print resolution of the image is less than the threshold, the image correction module 1203 increases the resolution through super-resolution processing. On the other hand, if it is determined that the print resolution of the image is greater than or equal to the threshold and is a sufficient resolution, no particular image correction is performed. In the first embodiment, super-resolution processing is performed when the print resolution of the image is less than 300 dpi.

Next, the processing advances to step S1305, and the font setting module 1204 sets the font obtained from the font selection module 216 to the skeleton data that was subject to image correction and was obtained from the image correction module 1203. FIG. 14C shows an example of a combination of fonts selected by the font selection module 216. In the first embodiment, an example of assigning a font when the font to be assigned to the image-corrected skeleton data has a font ID “2” in FIG. 14C will be described. In the first embodiment, the font is set for the character objects 1505, 1506, and 1507 of the skeleton 1508. Note that in posters, it is common to set a font that is noticeable for the title from the viewpoint of noticeability, and a font that is easy to read for the other characters from the viewpoint of visibility. For this reason, in the first embodiment, the font selection module 216 selects two types of fonts, namely a title font and a body font. The font setting module 1204 sets a title font for the character object 1505 whose attribute is “title”, and sets a body font for the other character objects 1506 and 1507. The font setting module 1204 outputs the skeleton data for which the fonts have been set to the text arrangement module 1205. Note that in the first embodiment, the font selection module 216 selects two types of fonts, but there is no limitation to this, and for example, the font selection module 216 may also select only the title font. In this case, the font setting module 1204 uses a font corresponding to the title font as the body font. In other words, it is sufficient that a body font that matches the type of the title font is set, such as selecting a typical Gothic font that is highly readable for the other text if the title is in a Gothic font, and selecting a typical Mincho font for the other text if the title is in a Mincho font. Of course, the title font and the body font may be the same. Also, different fonts may be used depending on the degree of noticeability desired, such as using a title font for character objects of the title and subtitle and using a body font for other character objects, or using a title font above a certain font size.

Next, the processing advances to step S1306, and the text arrangement module 1205 arranges the text specified by the text specifying module 202 in the skeleton data for which the font has been set and which was obtained from the font setting module 1204. In the first embodiment, each piece of text shown in FIG. 14A is assigned by referencing the metadata attributes of the character objects of the skeleton. In other words, the attribute “Big Summer Thank-You Sale”, whose attribute is a title, is assigned to the character object 1505, and the attribute “Blow away the midsummer heat”, whose attribute is a subtitle, is assigned to the character object 1506. In FIG. 14A, no main text has been set, and therefore nothing is assigned to the character object 1507.

FIG. 15C shows a skeleton 1509, which is an example of skeleton data after processing by the text arrangement module 1205. The text arrangement module 1205 outputs skeleton data in which the text has been arranged to the text decoration module 1206.

Next, the processing advances to step S1307, and the text decoration module 1206 adds decoration to the character objects in the skeleton for which the text has been arranged and which was obtained from the text arrangement module 1205. In the first embodiment, if the color difference between the title characters and the background area is less than or equal to a threshold value, processing for adding a border to the title characters is performed. This improves the readability of the title. The text decoration module 1206 outputs the decorated skeleton data, that is, the poster data for which all layout has been completed, to the impression estimation module 218.

Finally, the processing advances to step S1308, and the layout module 217 determines whether all poster data has been generated. If the layout module 217 determines that poster data has been generated for all combinations of skeletons, color patterns, and fonts, the layout module 217 ends this layout processing and transitions to step S911 in FIG. 9A. On the other hand, if it is determined that all of the poster data has not been generated, the processing returns to step S1301 and poster data is generated for combinations that have not yet been generated. This concludes the description of step S910. The description will return to FIG. 9A.

In step S911, the impression estimation module 218 executes rendering processing on each piece of poster data obtained from the layout module 217, estimates the impression of each of the rendered poster images, and associates the estimated impression with each piece of the poster data. Note that rendering processing is processing for converting poster data into image data. For example, even if the color pattern is the same, the layout will change if the skeleton is different, and therefore the area in which each color is actually used will differ. For this reason, since it is necessary to evaluate not only the trends of the individual impressions of the color pattern and the skeleton, but also the impression of the final poster, this processing is executed at this timing. This makes it possible to evaluate not only the impressions of individual elements of the poster, such as the color scheme and arrangement, but also the impression of the laid-out final poster, including images and characters.

Next, the processing advances to step S912, and the quality estimation module 221 executes rendering processing on each piece of poster data obtained from the layout module 217, estimates the quality of each of the rendered poster images, and associates the obtained estimated quality with each piece of the poster data. Note that, as the quality learning means, if feature amounts calculated from poster data are used as input, the same feature amounts are calculated from the poster data and then the quality of the poster is estimated.

Next, the processing advances to step S913, and an evaluation value calculation module 222 calculates an evaluation value that serves as an index for selecting a poster, based on the poster data obtained from the impression estimation module 218 and the quality estimation module 221, and the weighting obtained from the weighting designation module 223.

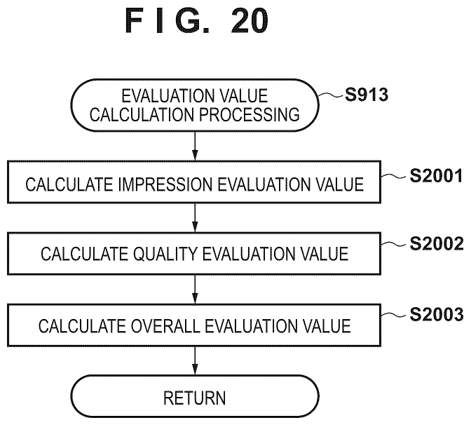

FIG. 20 is a flowchart for describing the evaluation value calculation processing in step S913.

In step S2001, the evaluation value calculation module 222 compares the target impression specified in the target impression designation module 204 with each estimated impression associated with the plurality of pieces of poster data obtained from the impression estimation module 218, and calculates an impression evaluation value. In the first embodiment, the evaluation value calculation module 222 calculates the distance between the target impression and the estimated impression of the poster as the impression evaluation value. Note that in the first embodiment, Euclidean distance is used as the distance. The smaller the value indicating the Euclidean distance is, the closer the estimated impression is to the target impression. Also, the distance calculated by the evaluation value calculation module 222 is not limited to the Euclidean distance, and may be a distance between vectors, such as Manhattan distance or cosine similarity.

Next, the processing advances to step S2002, and the evaluation value calculation module 222 compares the target quality designated in the target quality designation module 220 with the estimated quality associated with the plurality of pieces of poster data obtained from the quality estimation module 221, and calculates a quality evaluation value. In the first embodiment, the evaluation value calculation module 222 calculates the quality evaluation value according to the following Equation (3).

$$Quality evaluation value = MAX ( ( target quality - estimated quality ) , 0 ) \qquad Equation ( 3 )$$

Here, MAX ((x), 0) is a function that outputs the greater of x and 0. For example, if the target quality is 4 and the estimated quality is 3, then x=1 and the quality evaluation value is 1. On the other hand, if the target quality is 4 and the estimated quality is 5, then x=−1 and the quality evaluation value is 0. In other words, the quality evaluation value is the difference if the estimated quality of the generated poster does not achieve the target quality, and is 0 if the estimated quality achieves the target quality. Note that the method for calculating the quality evaluation value by the evaluation value calculation module 222 is not limited to Equation (3), and any method may be used as long as it is possible to calculate the degree of achievement of the target quality.

Next, the processing advances to step S2003, and the evaluation value calculation module 222 calculates an overall evaluation value for selecting poster data, based on the impression evaluation value calculated in step S2001, the quality evaluation value calculated in step S2002, and the weighting obtained from the weighting designation module 223. In the first embodiment, the evaluation value calculation module 222 calculates the overall evaluation value according to the following Equation (4).

$$Overall evaluation value = \{ ( 1 - weighting ) \times impression evaluation value \} + ( weight \times quality evaluation value ) \qquad Equation ( 4 )$$

Note that the method for calculating the overall evaluation value by the evaluation value calculation module 222 is not limited to Equation (4). For example, Equation (4) may be applied after applying a nonlinear function to the quality evaluation value to make the influence of the quality evaluation value more extreme. The evaluation value calculation module 222 associates each calculated evaluation value with the poster data and outputs it to the poster selection module 219. This concludes the description of step S913. The description will return to FIG. 9A.

In step S914, the poster selection module 219 selects posters to be output to the display 105 (to be presented to the user) from the poster data obtained from the evaluation value calculation module 222 and the overall evaluation values associated with the poster data. In the first embodiment, the poster selection module 219 selects posters in ascending order of overall evaluation value, that is, in descending order of evaluation, the number of selected posters being the number of posters to be created, which was designated by the poster generating condition designation module 201. Note that the method for selecting the posters is not limited to this. For example, as a selection method that emphasizes the degree of matching between the target impression and the estimated impression, posters whose impression evaluation value is less than or equal to a predetermined threshold, that is, posters having a high evaluation greater than or equal to a predetermined value, are selected as selection candidate posters. Then, from among these, posters may be selected in ascending order of overall evaluation value, that is, in descending order of evaluation, the number of selected posters being the number of posters to be created. As a selection method that emphasizes the degree of achievement of a target quality, posters having a quality evaluation value that is less than or equal to a predetermined threshold, that is, a quality evaluation value that is greater than or equal to a predetermined value, are set as selection candidate posters. Then, from among these, posters may be selected in ascending order of overall evaluation value, that is, in descending order of evaluation, the number of selected posters being the number of posters to be created. Also, in order to enable these poster selection methods to be explicitly specified, a list box for specifying a selection method (not shown) may be provided on the application start-up screen 501, and the selection method specified in the box may be executed.

Also, in each selection method, if the number of posters selected by the poster selection module 219 is less than the number of poster to be created, which was designated by the poster generating condition designation module 201, the poster selection module 219 may select the missing posters from posters other than the selection candidate posters in ascending order of overall evaluation value, that is, in descending order of overall evaluation. Alternatively, a message indicating that there is a shortage of candidates for posters may be displayed on the poster preview screen 601. Alternatively, the poster selection module 219 may select the missing posters and display them on the poster preview screen 601 such that posters whose impression evaluation value or quality evaluation value is less than or equal to a threshold value, that is, posters whose impression or quality evaluation is higher than the threshold value, can be distinguished from posters whose impression evaluation value or quality evaluation value is greater than or equal to the threshold value, that is, posters whose impression evaluation or quality evaluation is lower than the threshold value. Also, for example, if the selected posters are insufficient, the processing may return to step S903 and the number of skeletons, color patterns, and fonts that are selected may be increased.

The processing then advances to step S915, and the poster display module 205 renders the poster data selected by the poster selection module 219 and outputs poster images to the display 105. That is, the poster preview screen 601 in FIG. 6 is displayed.

The above is a description of the poster generation processing flow in which a poster is generated by the user designating a target impression and a target quality.

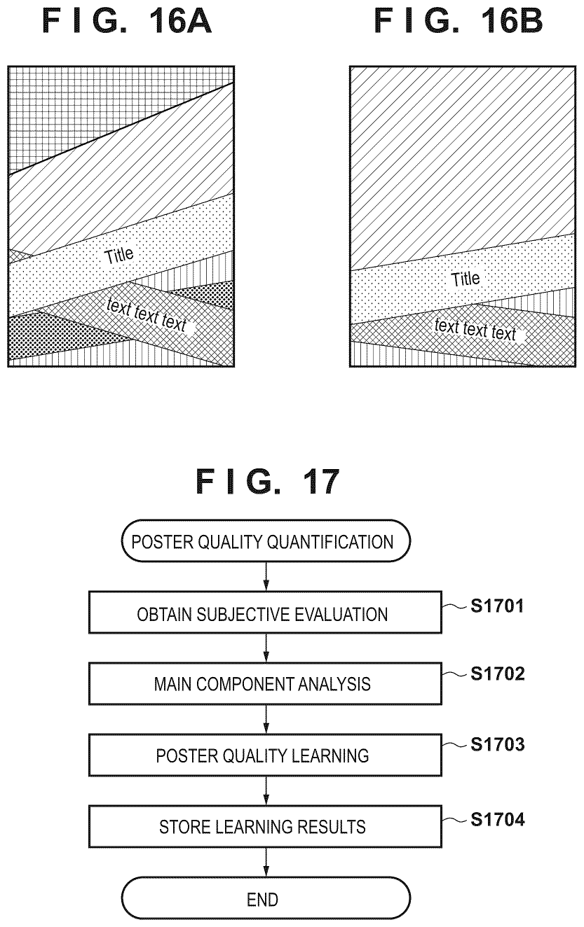

As described above, according to the first embodiment, by controlling the balance between emphasizing the target impression and emphasizing the target quality, it is possible to generate a poster that reflects the user's intention regarding impression and quality as much as possible under the generation conditions. Specifically, in the first embodiment, poster candidates of a plurality of variations according to the target impression are generated by combining the elements that constitute a poster, such as skeletons, color patterns, and fonts, based on the target impression. Furthermore, by estimating the overall impression of each of the poster candidates and evaluating the distance from the target impression, it is evaluated whether the overall impression, not just individual elements, aligns with the user's intention. Also, by estimating the quality of each of the poster candidates and evaluating the difference from the target quality, it is evaluated whether the quality achieves the user's intention. Then, by selecting a poster taking into account both the impression evaluation and the quality evaluation, a poster can be generated that expresses the degree of impression desired by the user and achieves the quality desired by the user. More specifically, for example, in the first embodiment, the target impression on the application start-up screen 501 is set to premium nature −1, affinity+1, and degree of dynamism and gravitas are each set to off, and the target quality is designated as +3.6. At this time, for example, the poster image 602 on the poster preview screen 601 is generated with an estimated impression close to the target impression and with an estimated quality that achieves the target quality, such as premium nature −1.2, affinity+0.9, degree of dynamism +0.2, degree of gravitas −1.3, and quality +3.8. Also, according to the first embodiment, it is possible to perform control such that low-quality posters such as those shown in FIG. 16A are not proposed to users.

Note that in the above-described first embodiment, the evaluation value is the difference (distance) from the target impression or the difference (distance) from the target quality, and therefore an evaluation value smaller than a threshold value is considered to be high. However, the present disclosure is not limited to this, and by making the evaluation value larger the smaller the above-described difference (distance) is, the evaluation may be considered to be high when the evaluation value is greater than a threshold value.

### Modified Example of First Embodiment

In the first embodiment, the poster preview screen 601 is displayed in order to output the generated poster images to the display 105, but the estimated impression and estimated quality of the poster may also be displayed together.

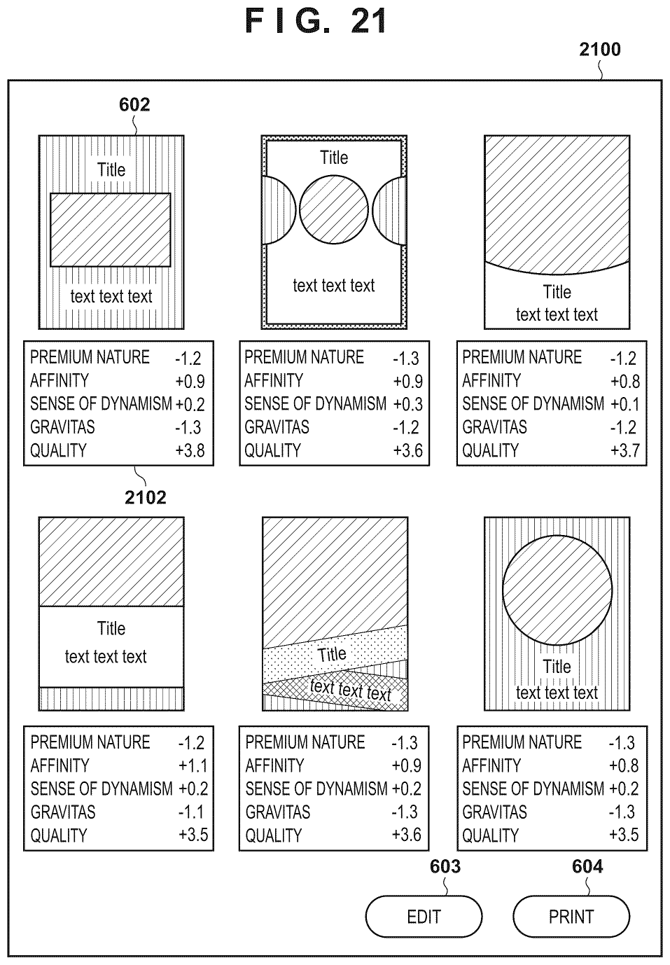

FIG. 21 is a diagram showing an example of a poster preview screen 2100 on which poster images generated by the poster display module 205 according to a modified example of the first embodiment are displayed on the display 105. When the OK button 517 on the application start-up screen 501 is pressed and poster generation is completed, the screen displayed on the display 105 transitions to the poster preview screen 2100. Configurations having the same numbers as those in FIG. 6 perform the same processing as that described above in the first embodiment, and therefore description thereof will be omitted here.

The estimation values display area 2102 is an area for displaying the estimated impression of the poster output by the impression estimation module 218 and the estimated quality of the poster output by the quality estimation module 221. In the modified example of the first embodiment, the impression estimation module 218 associates the estimated impression estimated in step S911 with the poster data, and the quality estimation module 221 associates the estimated quality estimated in step S912 with the poster data. This enables the poster display module 205 to refer to the estimated impression and estimated quality associated with the poster data, and to display the estimation values in the estimation values display area 2102. Note that in the estimation values display area 2102, only some of the estimation values for the degree of impression and quality that can be set on the application start-up screen 501 may be displayed. For example, estimation values may be displayed for items for which the impression radio button 512 or the quality radio button 519 is turned on.

As described above, according to the modified example of the first embodiment, the user can confirm the extent to which the intended degree of impression and quality are reflected in the generated poster. For this reason, the user can use this to select a poster to edit or print, or to provide feedback such as reviewing the settings on the application start-up screen 501.

### Second Embodiment

In the above-described first embodiment, an example has been described in which the degree of impression and quality of a poster are evaluated based on a target impression and a target quality, and a poster that reflects a user's intention is generated and selected. In contrast, in the second embodiment, an embodiment will be described in which, when the quality evaluation value of a poster does not achieve a predetermined threshold, the poster data is modified so as to improve the quality. This increases the number of posters that better reflect the user's intention, allowing the user to select a desired poster from a wider variety of candidates.

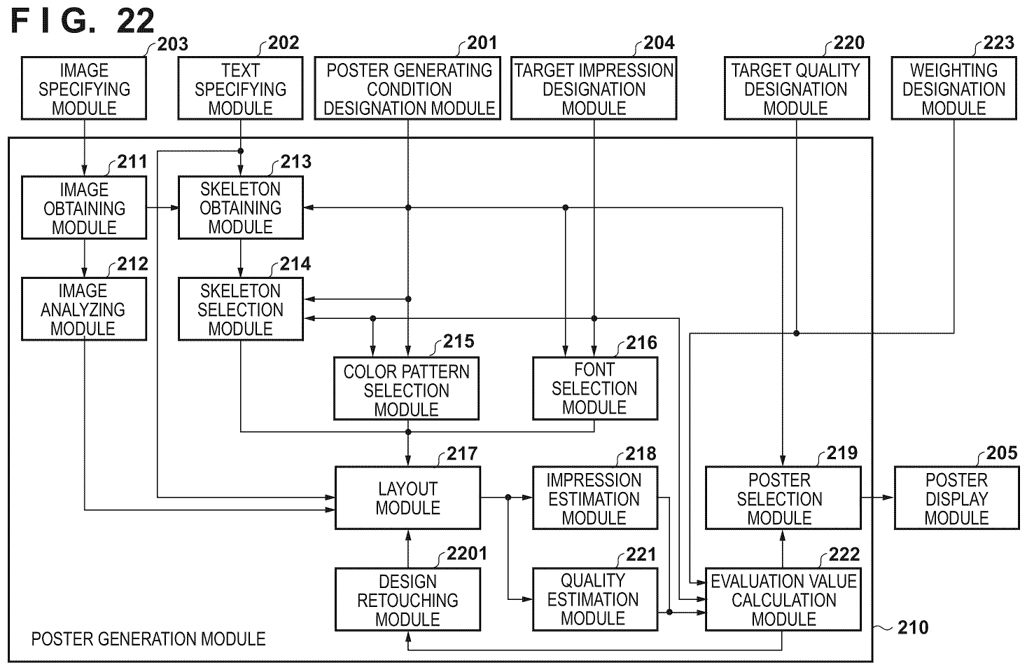

FIG. 22 is a functional block diagram for describing the functions of a poster creation application according to the second embodiment. In the configuration of the block diagram shown in FIG. 22, a design retouching module 2201 is added. Note that configurations having the same numbers as those in FIG. 2 perform the same processing as that described in FIG. 2 of the first embodiment, and therefore description thereof will be omitted here.

The design retouching module 2201 obtains poster data associated with a quality evaluation value from the evaluation value calculation module 222. The design retouching module 2201 retouches the poster data if the quality evaluation value associated with the poster data is greater than a predetermined threshold value. The design retouching module 2201 then outputs the retouched poster data to the layout module 217.

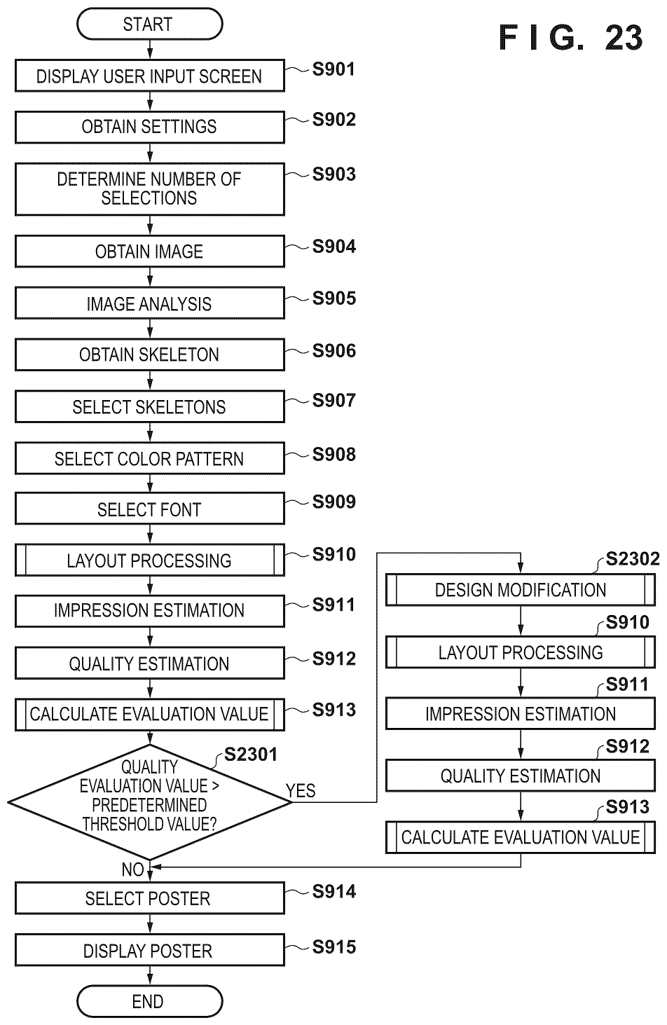

FIG. 23 is a flowchart for describing processing performed by the poster generation module 210 of the poster creation application according to the second embodiment. Note that in this flowchart, the processing denoted by the same numbers as those in the flowchart of FIG. 9A is the same as that described in the first embodiment, and therefore description thereof will be omitted here.

In step S2301, the design retouching module 2201 determines whether or not the quality evaluation value associated with the poster data obtained from the evaluation value calculation module 222 is greater than a predetermined threshold value. In the second embodiment, it is determined whether or not the quality evaluation value is greater than 0, that is, whether or not the estimated quality has achieved the target quality. If it is determined that the quality evaluation value associated with the poster data is greater than 0, in other words, in a case that the estimated quality has not achieved the target quality, the processing transitions to step S2302. If it is determined that the quality evaluation value associated with the poster data is less than or equal to 0, the processing transitions to step S914 and no retouching is performed on the poster data.

In step S2302, the design retouching module 2201 retouches the poster data to improve the quality of the poster.

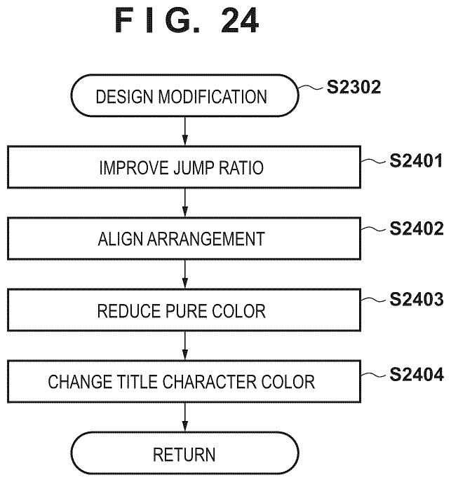

FIG. 24 is a flowchart for describing retouching processing (S2302) for poster data performed by the design retouching module 2201 according to the second embodiment.

In step S2401, the design retouching module 2201 increases the character size of the title to improve the jump ratio of the font size. As mentioned above, the jump ratio is the ratio of the size of large elements to the size of small elements, and a high jump ratio makes important information more noticeable in a design. By increasing the font size of the title, which is important character information, and increasing the jump ratio, the title is noticeable and the quality of the poster is improved in terms of noticeability. First, the jump ratio of the title is calculated by calculating the ratio of the character size of the character object whose attribute is “title” to the average character size of all character objects. Then, if the obtained jump ratio is less than a predetermined threshold, the character size of the title is increased until the jump ratio reaches the predetermined threshold. In the second embodiment, if the character size of the title is less than twice the average value of all character sizes, the title character size is increased.

Next, the processing advances to step S2402, and the design retouching module 2201 aligns the arrangement of the character objects. In poster design, aligning the arrangement position of each character object improves readability and reduces awkwardness caused by slight positional misalignment, thereby improving the quality of the poster. First, the character position attribute of each character object is referenced, and character objects having the same character position attribute are grouped together. Then, among the plurality of character objects belonging to the same group, if there is a combination of character objects whose difference in arrangement position is less than or equal to a predetermined threshold, the arrangement positions of those character objects are aligned. At this time, for a group with a character position attribute of left alignment, the arrangement position of the other character object is aligned with the character object whose arrangement position is further to the left. For a group with a character position attribute of center, the arrangement positions of both character objects are aligned at the center of the arrangement positions of both character objects. For a group with a character position attribute of right alignment, the arrangement position of the other character object is aligned with the character object whose arrangement position is further to the right. In the second embodiment, if the difference in the arrangement positions of character objects is 2 mm or less, the arrangement positions are aligned.

Next, the processing advances to step S2403, and the design retouching module 2201 changes the pure colors included in the color pattern. A pure color is a color that is the most saturated of all hues. In poster design, it is desirable to avoid using pure colors, as they are hard to see and cause eye strain, lowering the quality of the poster. In the second embodiment, if the color pattern of the poster data includes a color with a saturation of 95% or more in the HSV color space, the saturation of that color is changed to 95%. Also, the design retouching module 2201 changes pure black or pure white included in the color pattern. Pure black is a completely black color with all RGB values at 0, and pure white is a completely white color with all RGB values at 255. In poster design, pure black is a very strong color that does not blend well with the design, and pure white gives a cheap impression, and therefore it is desirable to avoid using pure black and pure white. In the second embodiment, if the color pattern of the poster data includes a color with a brightness of 5 or less in the L*a*b* color space, the brightness of that color is changed to 5. Also, if the color pattern of the poster data includes a color with a brightness of 95 or more in the L*a*b* color space, the brightness of that color is changed to 95.

Next, the processing advances to step S2404, and the design retouching module 2201 changes the character color of the title. Color 4 of the color pattern was assigned to the character color of the title in step S1302 of FIG. 13, but depending on the color of the graphic object or image object arranged in the background of the character object, the visibility of the title may decrease, reducing the quality of the poster. For this reason, if the visibility of the title is low, the character color of the title is changed to increase the visibility of the title and improve the quality of the poster. First, it is determined whether or not the difference in brightness between the character color of the character object whose attribute is “title” and the background area of the character object is less than a threshold value. In the second embodiment, the threshold value is set to 30. Then, for character objects whose brightness difference is less than the threshold value, if the brightness of the background of the character object is less than or equal to the threshold value, the character color is set to white, and if not, the character color is set to black. In the second embodiment, the threshold value is set to 50.

This concludes the description of the design retouching processing of step S2302. The processing in step S2302 retouches the constituent elements of the poster, such as the arrangement, color scheme, and font. FIG. 23 will be returned to.

In steps S910 to S913 following step S2302, the above-mentioned processing is executed again to calculate and associate an overall evaluation value also for the poster data resulting from design retouching. The processing then advances to step S914, and the poster selection module 219 selects posters to be output to the display 105 (to be presented to the user) from the poster data obtained from the evaluation value calculation module 222 and the overall evaluation value associated with the poster data. In the second embodiment, first, in step S2302, an overall evaluation value associated with the poster data whose design has been retouched is compared with an overall evaluation value associated with the poster data before the design modification. Then, poster data associated with a larger overall evaluation value, that is, poster data associated with a worse evaluation, is excluded from the selection candidates. Thereafter, similarly to the first embodiment, in step S914, the poster selection module 219 selects posters in ascending order of overall evaluation value, the number of selected posters being the number of posters to be created, which was designated by the poster generating condition designation module 201.

As described above, according to the second embodiment, if the quality evaluation value of the poster does not achieve a predetermined threshold value, the poster data is retouched to improve the quality of the poster. Although design retouching can improve the quality of the poster, it may also change the impression given by the poster, and therefore the degree of impression and quality are evaluated again, and posters with higher evaluations are selected. This increases the number of posters that better reflect the user's intention, and therefore the user can select a desired poster from a wider variety of poster candidates.

### Modified Example of Second Embodiment

In the second embodiment, in order to improve the quality of the poster, the poster data is retouched in step S2302, but the implementation of each design retouching processing may be switched on or off based on the target impression.

The difference in data flow between the second embodiment and this modified example will be described with reference to FIG. 22.

In this modified example, the evaluation value calculation module 222 associates the target impression received from the target impression designation module 204 with the poster data to be output to the design retouching module 2201.

The difference between the poster data retouching processing in the second embodiment and this modified example will be described with reference to FIG. 24.

In step S2401, the design retouching module 2201 improves the jump ratio of the title only when the value of the degree of dynamism is greater than or equal to a threshold value or the value of the premium nature is less than or equal to a threshold value, among the target impressions associated with the poster data. This is because in some cases, the jump ratio is deliberately set low when the user wants to give a calm impression or a premium nature impression. In this modified example, retouching for improving the jump ratio of the title is carried out only when the target degree of dynamism is 0 or more and the premium nature is 0 or less.

In step S2403, the design retouching module 2201 changes the pure colors only when the value of the degree of dynamism is less than or equal to a threshold value among the target impressions associated with the poster data. This is because pure colors are deliberately used in some cases when the user wants to give a dynamic impression or an energetic impression. In this modified example, the pure colors are changed only when the target degree of dynamism is 0 or less. Also, the design retouching module 2201 changes pure black only when the value of the premium nature or the value of the degree of gravitas is less than or equal to a threshold value among the target impressions associated with the poster data. This is because pure black is deliberately used in some cases when the user wants to give a premium nature or a degree of gravitas. In this modified example, pure black is changed only if the target premium nature is 0 or less and the degree of gravitas is 0 or less. Also, the design retouching module 2201 changes pure white only when the value of the premium nature is greater than or equal to a threshold value among the target impressions associated with the poster data. This is because pure white is used deliberately in some cases when the user wants to give a cheap impression. In this modified example, pure white is changed only when the target premium nature is 0 or more.

As described above, according to the modified example of the second embodiment, it is possible to improve the quality of poster data while also taking into account the target impression.

### OTHER EMBODIMENTS

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-140271, filed Aug. 30, 2023, which is hereby incorporated by reference herein in their entirety.

What is claimed is:

1. An information processing apparatus comprising:
one or more controllers including one or more processors and one or more memories, the one or more controllers configured to:
receive, from a user, a designation of a target impression of a poster to be generated;
receive, from a user, a designation of a target quality of the poster to be generated;
generate one or more pieces of poster data based on at least the target impression;
calculate an evaluation value based on first information indicating a difference between the target impression and a degree of impression of each of the one or more pieces of poster data and second information indicating a difference between the target quality and a quality of each of the one or more pieces of poster data; and
select, from the one or more pieces of poster data, a poster for which the evaluation value has an evaluation higher than a predetermined evaluation.

2. The information processing apparatus according to claim 1,
wherein in the calculation of the evaluation value, the one or more controllers calculate the evaluation value using the second information if the quality of each of the one or more pieces of poster data does not achieve the target quality, and the one or more controllers calculate the evaluation value using 0 as the second information if the quality of each of the one or more pieces of poster data achieves the target quality.

3. The information processing apparatus according to claim 1,
wherein the difference is expressed as a Euclidean distance.

4. The information processing apparatus according to claim 1,
wherein in the generation of the one or more pieces of poster data, the one or more controllers generate the one or more pieces of poster data by arranging at least one of an image, text, and a graphic to be used in the poster, according to layout information.

5. The information processing apparatus according to claim 1,
wherein in a case that respective designations of the target impression and the target quality are to be received from a user, the one or more controllers display a screen for receiving the respective designations from the user and receive the respective designations of the target impression and the target quality via the screen.

6. The information processing apparatus according to claim 5,
wherein the screen displays sliders as objects for respectively designating the target impression and the target quality, and
the one or more controllers receive the respective designations of the target impression and the target quality according to an operation of the sliders performed by the user.

7. The information processing apparatus according to claim 1,
wherein the quality of the poster is expressed as a numeric value calculated based on at least one evaluation value among balance, noticeability, and visibility of a design of the poster.

8. The information processing apparatus according to claim 1,
wherein the one or more controllers are further configured to:
receive, from a user, weighting information indicating weighting of the target impression and the target quality, and
in the calculation of the evaluation value, the one or more controllers calculate the evaluation value based on the weighting information, information indicating a difference between the target information and a degree of impression of the poster data, and information indicating a difference between the target quality and the quality of each of the one or more pieces of poster data.

9. The information processing apparatus according to claim 1,
wherein in the selection of the poster data, when a plurality of pieces of poster data are generated, the one or more controllers select poster data for which the evaluation value has an evaluation higher than a predetermined evaluation from the plurality of pieces of poster data, the number of pieces of selected poster data being at least a number obtained based on a number of posters to be created, which was designated by the user.

10. The information processing apparatus according to claim 1,
wherein the one or more controllers are further configured to:
display a poster image based on the selected poster data.

11. The information processing apparatus according to claim 9,
wherein in the selection of the poster data, the one or more controllers select poster data for which the evaluation value has an evaluation higher than a predetermined evaluation, in descending order of the evaluation.

12. The information processing apparatus according to claim 10,
wherein in the display, the one or more controllers display a degree of impression and a quality of the poster image.

13. The information processing apparatus according to claim 1,
wherein in the generation of the one or more pieces of poster data, the one or more controllers re-generate poster data that is different from the poster data if the information indicating the difference between the target quality and the quality of each of the one or more pieces of generated poster data is larger than a predetermined threshold value.

14. The information processing apparatus according to claim 13,
wherein in the generation of the one or more pieces of poster data, the one or more controllers generate poster data different from the poster data by changing at least one of an arrangement, a color scheme, and a font in the poster data in the re-generation.

15. The information processing apparatus according to claim 13,
wherein in the generation of the one or more pieces of poster data, the one or more controllers determine whether or not to change the arrangement or the color scheme in the one or more pieces of poster data based on the target impression.

16. A method of controlling an information processing apparatus, the method comprising:
receiving, from a user, a designation of a target impression of a poster to be generated;
receiving, from a user, a designation of a target quality of the poster to be generated;
generating one or more pieces of poster data based on at least the target impression;
calculating an evaluation value based on first information indicating a difference between the target impression and a degree of impression of each of the one or more pieces of poster data and second information indicating a difference between the target quality and a quality of each of the one or more pieces of poster data; and
selecting, from the one or more pieces of poster data, poster data for which the evaluation value has an evaluation higher than a predetermined evaluation.

17. A non-transitory computer-readable storage medium storing a program for causing a processor to execute a method of controlling an information processing apparatus, the method comprising:
receiving, from a user, a designation of a target impression of a poster to be generated;
receiving, from a user, a designation of a target quality of the poster to be generated;
generating one or more pieces of poster data based on at least the target impression;
calculating an evaluation value based on first information indicating a difference between the target impression and a degree of impression of each of the one or more pieces of poster data and second information indicating a difference between the target quality and a quality of each of the one or more pieces of poster data; and
selecting, from the one or more pieces of poster data, poster data for which the evaluation value has an evaluation higher than a predetermined evaluation.
